(19) United States
(12) Patent Application Publication
(10) Pub. No.: US 2015/0307212 A1
(43) Pub. Date: Oct. 29, 2015

(54) Washing System

(71) Applicant: Petter Investments, South Haven, MI (US)

(72) Inventors: Matthew J. Petter, South Haven, MI (US); Douglas A. Petter, South Haven, MI (US)

(73) Assignee: Petter Investments, South Haven, MI (US)

(21) Appl. No.: 14/261,093

(22) Filed: Apr. 24, 2014

(51) Int. Cl. B64F 5/00; B08B 3/02; B08B 3/14

(52) U.S. Cl. CPC B64F 5/0018; B08B 3/14; B08B 3/02

(57) ABSTRACT

A washing system includes one or more fluid cannons and a data processing device. The cannons are arranged about a rinsing area for rinsing an object. The data processing device is in communication with the one or more fluid cannons and executes a rinsing routine for rinsing the object within the rinsing area. The rinsing routine causes the data processing devise to issue one or more commands based on an object type that causes the one or more fluid cannons to aim toward the object spray and spray a fluid for a threshold period of time.

### TECHNICAL FIELD

This disclosure relates to washing or rinsing systems for objects, such as airplanes.

### BACKGROUND

Airplanes get very dirty as they fly over land or sea. Dust may settle on the surface of the airplane and may get streaked by rain or other liquids. In addition, the airplane's extensive hydraulic system may leak oils. Pilots may sometimes reverse the thrust of an airplane's engines to slow the airplane in preparation for landing, which causes dirty air from the engine to blow on the sides and tails of the airplane. Another cause of airplanes getting dirty is bugs that hit the airplane as it is flying.

Corrosion is the deterioration of a metal because of its chemical reaction with the surrounding environment. Although new and improved metals and materials are being developed, corrosion is a complex phenomenon because it is variable due to the different environmental factors (e.g., wind, rain, sun, water vapor). In addition, the resistance of airplane materials to corrosion can drastically change due to a small change in the environment. When airplanes fly over the sea, water or water vapor containing salt combines with oxygen in the atmosphere to produce the main source of corrosion in airplanes. Therefore, airplanes operating in a marine environment or in areas where the atmosphere contains corrosive industrial fumes are more vulnerable to corrosive attacks.

Maintaining an airplane by cleaning it and keeping it clean is extremely important to prevent the accumulation of unwanted dirt and corrosion. A clean airplane allows the technicians to better inspect the airplane for any corrosion or cracks that would otherwise be disguised by dirt and thus overlooked. Moreover, since salt water has a serious corroding effect on exposed metal parts of an airplane, the airplane should be washed quickly after its flight.

### SUMMARY

One aspect of the disclosure provides a washing system that includes one or more fluid cannons in communication with a data processing device. The cannons are arranged about a rinsing area for rinsing an object (e.g., airplane). The data processing device executes a rinsing routine for rinsing the object within the rinsing area. The rinsing routine causes the data processing device to issue one or more commands based on an object type that causes the one or more fluid cannons to aim toward the object and spray a fluid for a threshold period of time.

Implementations of the disclosure may include one or more of the following features. In some implementations, the data processing device receives a cannon position parameter and a cannon flow pattern parameter and configures one or more commands based on the received parameters.

The data processing device receives a selection of the object type from a group of selectable object types. The device then issues a position command to each fluid cannon. The position command is defined based on the object type to aim the fluid cannon toward the object. The device then issues a spray command to each fluid cannon. The spray command is defined based on the object type to spray a fluid from the fluid cannon for a threshold period of time. The rinsing area defines multiple rinse zones. A different rinsing routine is associated with each rinse zone. Each rinsing routine executes when the object advances through the rinse zone.

Each fluid cannon includes a pan actuator, a tilt actuator and a controller in communication with the actuators. The controller receives the position command from the data processing device and actuates the actuators based on the position command to aim the fluid cannon. Additionally or alternatively, the fluid cannon may include an adjustable nozzle and a nozzle actuator for adjusting the flow pattern of the nozzle. The spray command may include a flow pattern parameter, and the controller may actuate the nozzle actuator based on the flow pattern parameter. In some examples, the fluid cannon further includes a valve in fluid communication with the nozzle and a valve actuator adjusting a position of the valve. The spray command may include a flow rate parameter, and the controller may actuate the valve actuator based on the flow rate parameter.

In some implementations, for each rinse zone, the data processing device receives at least one of a position parameter, the flow pattern parameter or the flow rate parameter for each fluid cannon disposed in the rinse zone. The processing device further determines the position command and the spray command for each fluid cannon disposed in the rinse zone based on at least one parameter. The data processing device further determines a rinse zone threshold period of time for spraying fluid on the object in each rinse zone.

In some examples, the data processing device receives a wind correction parameter, wind data from a wind sensor and determines the position parameter based on the wind correction parameter and the wind data. Additionally or alternatively, the wind data may include one or more of a wind speed and a wind direction. The system may further include a user display in communication with the data processing device. The user display may display the wind correction parameter, the wind data and the position parameter.

In some implementations, the system further includes a filtration system in communication with the data processing device. The data processing device monitors collection and transfer of sprayed fluid to the filtration system. Moreover, the filtration system may include fluid drains for capturing fluid from the rinsing area and a recovery tank in fluid communication with the fluid drains. The recovery tank stores the captured fluid. The filtration system also includes a supply tank for storing the fluid filtered from the recovery tank. In some examples, the filtration system may further include a filtration valve in fluid communication with the recovery tank or the supply tank, a filtration valve actuator for adjusting a position of the filtration valve, and a filtration valve controller in communication with the filtration valve and the data processing device. The filtration valve controller receives a valve position command from the data processing device and actuates the filtration valve actuator based on the valve position command.

Another aspect of the disclosure provides a method for operating a data processing device. The method includes receiving, at a data processing device, a selection of an object type from a group of selectable object types for an object within a rinsing area. The method includes issuing one or more commands from the data processing device, to one or more fluid cannons arranged about the rinsing area and in communication with the data processing device. One or more commands are based on the object type and cause the one or more fluid cannons to aim toward the object and spray a fluid for a threshold period of time.

In some implementations, the method includes defining multiple rinse zones within the rinsing area. For each rinse zone, the method includes configuring one or more commands to execute when the object advances through the rinse zone. Additionally or alternatively, for each rinse zone, the method includes determining a rinse zone threshold period of time for spraying fluid on the object in the rinse zone.

In some implementations, the method includes receiving a cannon position parameter and a cannon flow pattern parameter and configuring the one or more commands based on the received parameters. The method may also include receiving a wind correction parameter and wind data from a wind sensor, at the data processing device. The method further includes determining, using the data processing device, the cannon position parameter based on the wind correction parameter and the wind data. The wind data may include one or more of a wind speed and a wind direction. The method may further include displaying the wind correction parameter, the wind data and the cannon position parameter, on a user display in communication with the data processing device.

In some examples, the one or more commands includes one or more positioning commands for positioning a respective fluid cannon and one or more pattern commands that set a spray pattern of the respective fluid cannon in some examples, the one or more commands includes one or more fluid rate commands that control a fluid valve in communication with the data processing device and in fluid communication with a respective fluid cannon and controlling a fluid rate to that fluid cannon. Additionally or alternatively, the method may further include defining multiple zones within the rinsing area, and configuring a fluid flow rate for at least one fluid cannon in at least one rinse zone.

The method may further include issuing a filtration command from the data processing device to a filtration system to collect fluid from the rinsing area and filter the collected fluid. In some examples, the filtration command includes a valve position command for actuating a filtration valve of the filtration system. The filtration valve controls a flow of fluid through the filtration system.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an exemplary overview of a washing system.

FIG. 1B is a schematic view of an exemplary overview of the washing system of FIG.

FIG. 1C is a side view of an exemplary stem of an adjustable pattern and adjustable flow nozzle.

FIG. 1D is a front view of an exemplary stem of the adjustable pattern and adjustable flow nozzle of FIG. 1C.

FIG. 1E is a side view of an exemplary stem of FIG. 1C of the adjustable pattern and adjustable flow nozzle.

FIG. 1F is a front perspective view of an exemplary adjustable pattern and adjustable flow nozzle.

FIG. 1G is an exploded view of the exemplary adjustable pattern and adjustable flow nozzle of FIG. 1F.

FIG. 1H is a side view of the exemplary adjustable pattern and adjustable flow nozzle of FIG. 1F.

FIG. 1I is a sectional view of the exemplary adjustable pattern and adjustable flow nozzle of FIG. 1F showing liquid flowing through the nozzle.

FIG. 2A is a schematic view of an exemplary untrained user main screen.

FIG. 2B is a schematic view of a block diagram of the washing system.

FIG. 3 is a schematic view of an exemplary water cannon control screen.

FIG. 4 is a schematic view of an exemplary setup screen.

FIG. 5 is a schematic view of an exemplary system prime screen.

FIG. 6 is a schematic view of art exemplary input/output screen.

FIG. 7 is a schematic view of an exemplary cannon progress screen.

FIG. 8 is a schematic view of an exemplary weather screen.

FIG. 9 is a schematic view of an exemplary filtration system screen.

FIG. 10 is a schematic view of an exemplary setpoint screen.

FIG. 11 is a schematic view of an exemplary pump setup screen.

FIG. 12 is a schematic view of an exemplary arrangement of operations for using a washing system.

Like reference symbols in the various drawings indicate like elements.

### DETAILED DESCRIPTION

Airplanes come in various shapes and sizes. It is desirable to have a washing system 100 capable of accommodating the different airplane shapes and sizes. It is also desirable to have a maintenance system that allows a user 40 to select an airplane type, and the system 100 automatically washes the airplane 20 based on preconfigured settings. As described below, the system 100 is configured to wash airplanes 20; however, the system 100 may be configured to wash any object, such as, but not limited to, trucks of different sizes, cars, machines, or any other objects of variable sizes. In addition, the system 100 may be configured to accommodate any multiple types of object of varying sizes.

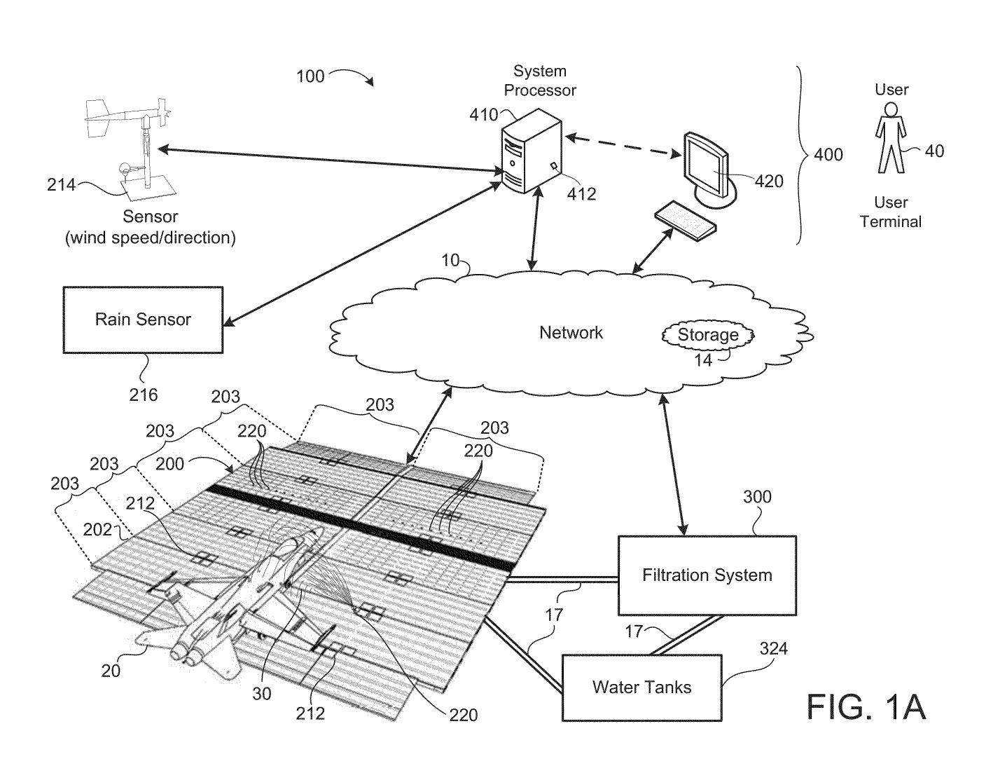

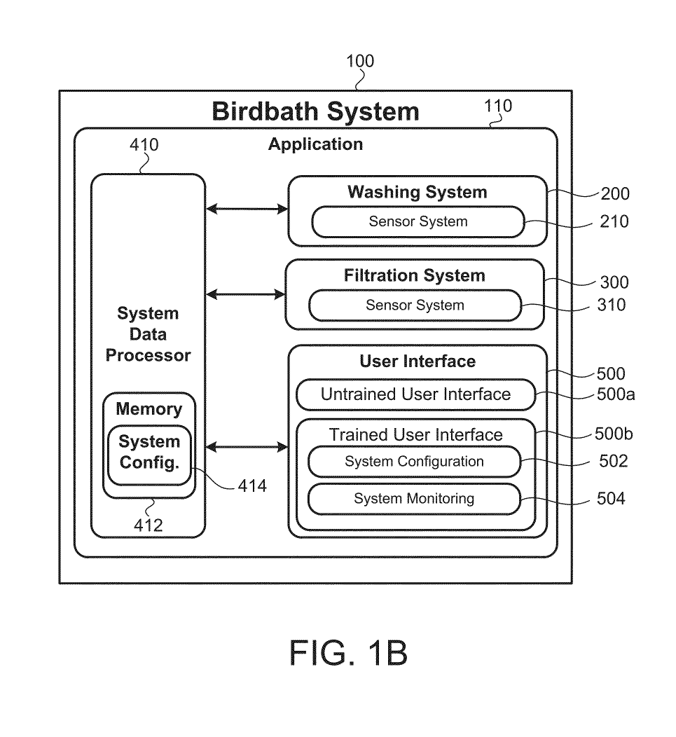

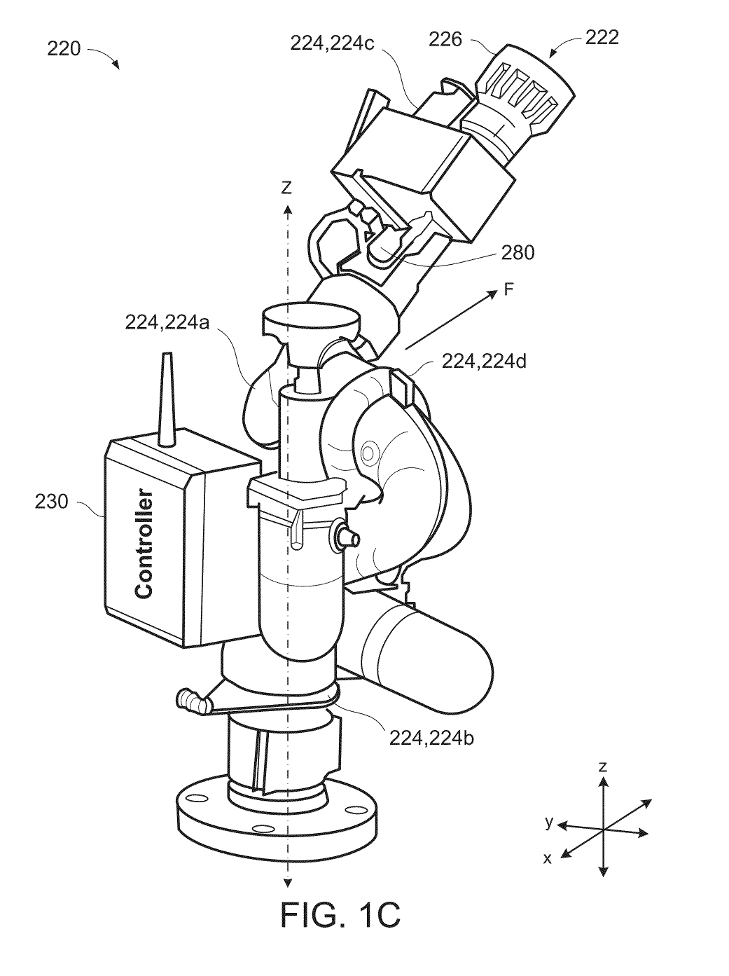

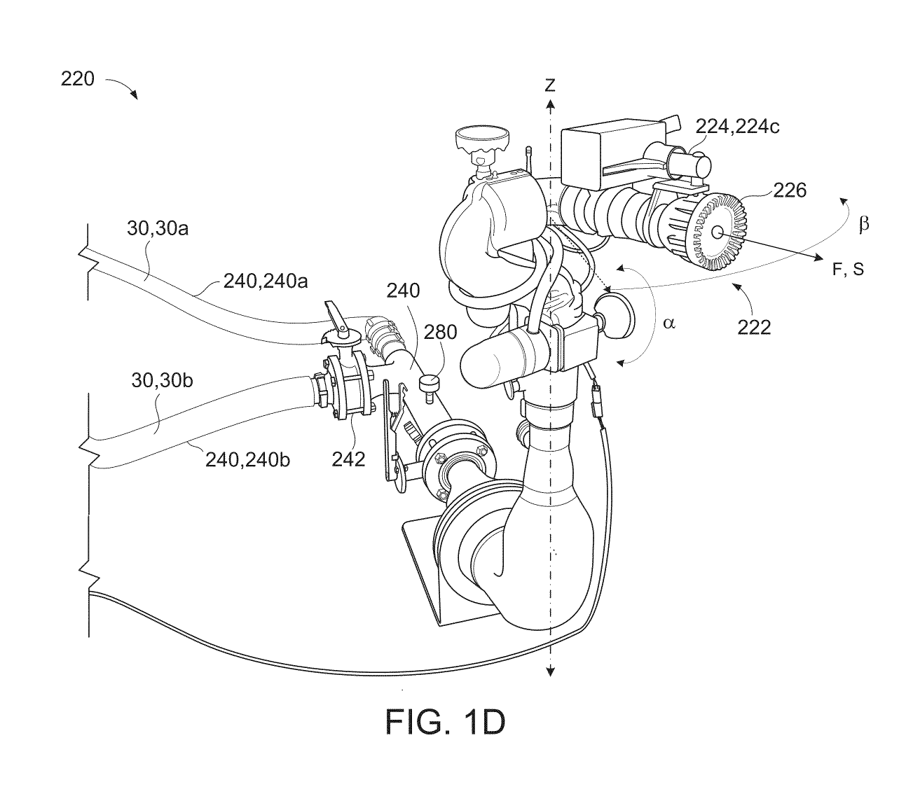

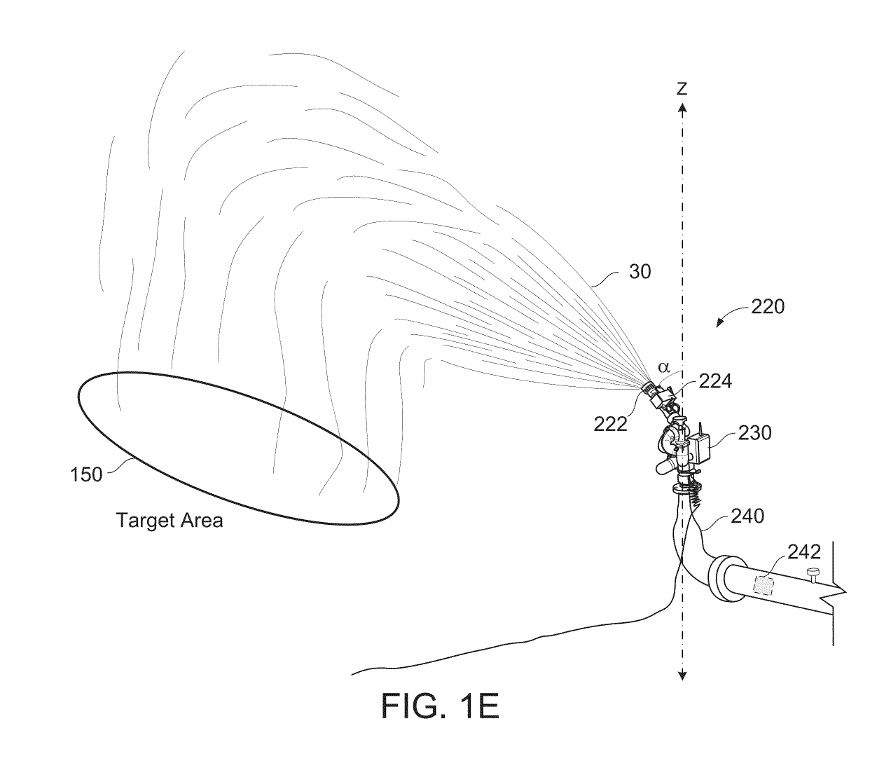

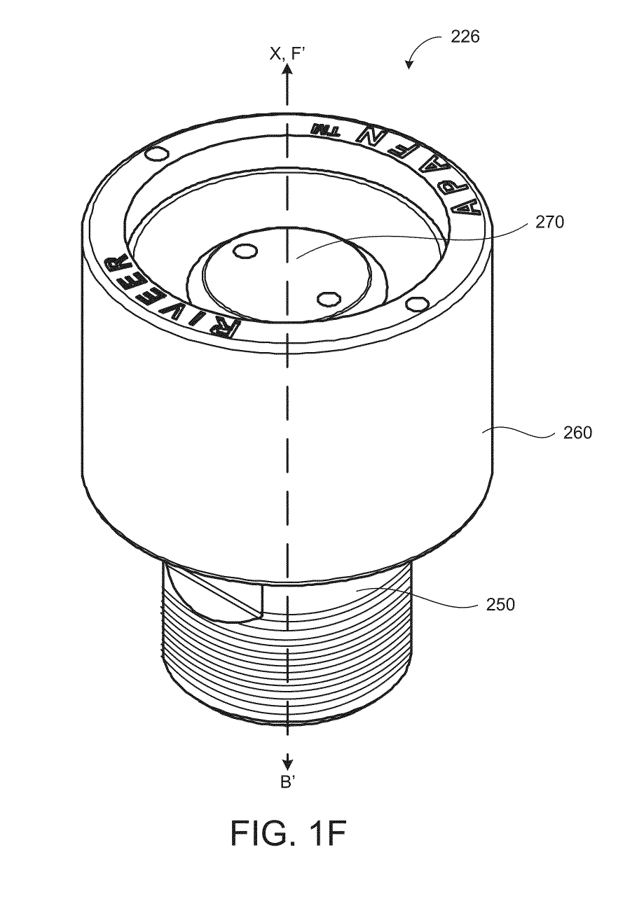

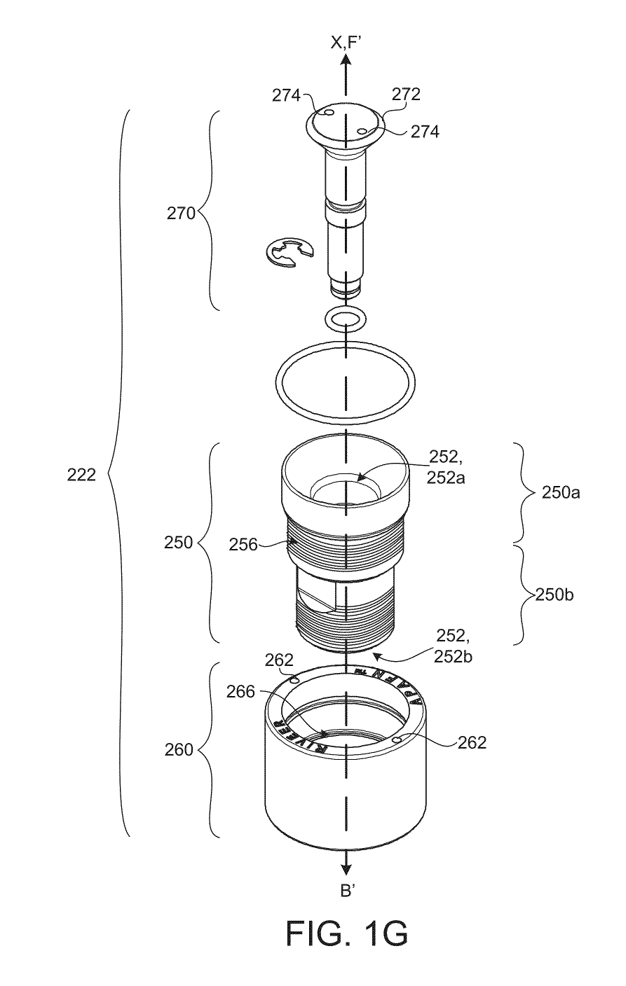

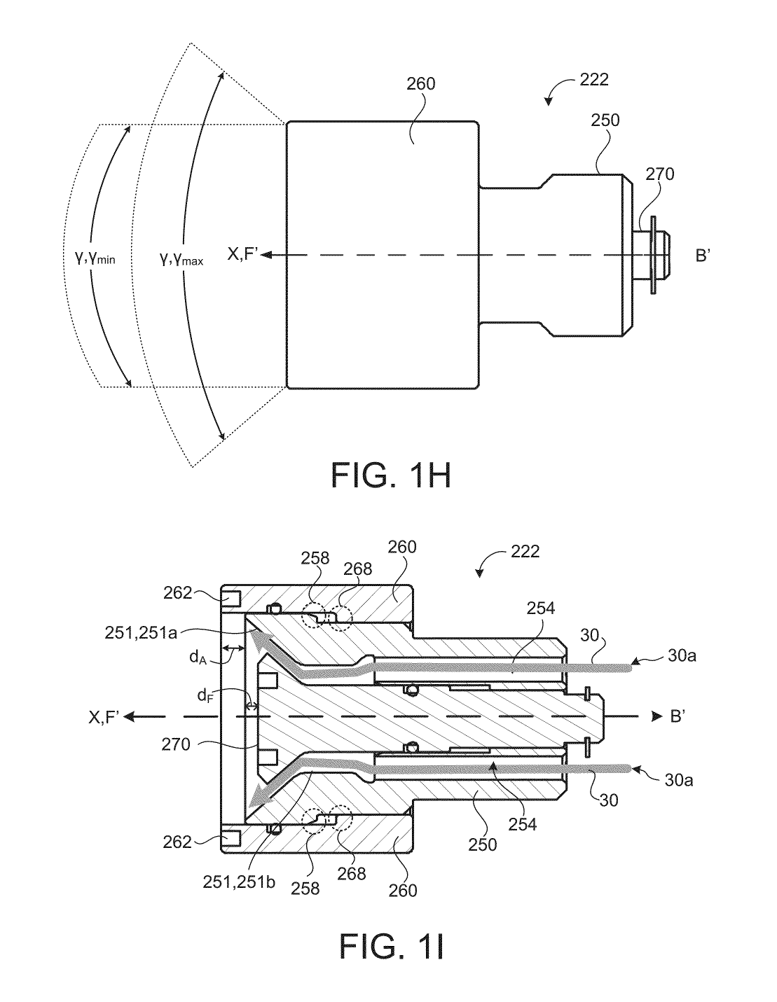

Referring to FIGS. 1A-1I, in some implementations, the washing system 100 includes a rinsing system 200, a filtration system 300, and a user terminal 400 all of which are connected via a network 10. The user terminal 400 includes a system data processor 410 in communication with a user display 420 for displaying a user interface 500.

In some examples, the system data processor 410 is a computer device that executes a set of instructions (stored in non-transitory memory 412 in communication with the system data processor 410) for an application 110 and displays a user interface 500 on a user display 420. The application 110 allows the system 100 to run a routine (e.g., a wash cycle) based on pre-configured settings (discussed below). Moreover, the application 110 allows for or facilitates interaction between the rinsing system 200 (e.g., washing sensor system 210), the filtration system 300 (e.g., filtration sensors 310), the user interface 500 (e.g., including trained and untrained user interfaces 500b, 500a), and the system data processor 410.

The washing system 100 may be operated by one user 40. The user 40 may control and interface with the washing system 100 via the user interface 500 without the need for a crew by the taxi-on rinse deck area 202. In addition, the system 100 includes multiple cannons 220 to ensure a thorough and efficient rinse of all surfaces of the airplane 20. Each cannon 220 may be pre-configured based on the type and size of airplane 20.

The network 10 may include any type of network that allows sending and receiving communication signals, such as a wireless telecommunication network, a cellular telephone network, a time division multiple access (TDMA) network, a code division multiple access (CDMA) network, Global system for mobile communications (GSM), a third generation (3G) network, fourth generation (4G) network, a satellite communications network, and other communication networks. The network 10 may include one or more of a Wide Area Network (WAN), a Local Area Network (LAN), and a Personal Area Network (PAN). In some examples, the network 10 includes a combination of data networks, telecommunication networks, and a combination of data and telecommunication networks. The system processor 410, the user interface 500, the rinsing system 200, and the filtration system 300 communicate with the network 10 by sending and receiving signals (wired or wireless). In some examples, an airplane 20 may be in communication with a global positioning system (GPS) satellite, global navigation satellite system (GNSS) or the like, for determining the position of the airplane 20 as it approaches the taxi-on rinse deck area 202. In some examples, the network 10 provides access to cloud computing resources, which may be elastic/on-demand computing and/or storage resources available over the network 10. The term ‘cloud’ services generally refers to a service performed not locally on a user's device, but rather delivered from one or more remote devices accessible via one or more networks 10. The system processor 410 and/or the user interface 500, may access cloud storage 14 (e.g., non-transitory memory) via a web browser or a web-based application in communication with the network 10 to access data relating to each user 40 remotely stored by the cloud storage 14.

The rinsing system 200 provides a taxi-on rinse deck area 202 sized to fit an object 20 (e.g., an airplane or any other object) being rinsed. For examples, the taxi-on rinse deck 202 fits small planes 20 to larger airplanes 20. The washing system 100 helps prevent airplane corrosion by rinsing the airplane 20 as it taxis back to a flight line or gate. In addition, the washing system 100 reclaims, filters, and recycles the fresh water 30 (e.g. fluid 30) it used to wash the object 20 (e.g., up to 80%). The washing system 100 uses clear water 30, because it helps reduce and control corrosion by removing corrosive agents (e.g., dirt and salt) on a frequent basis between scheduled washes.

In some examples, the rinsing system 200 includes cannons 220, water tanks 324, wind speed and direction sensors 214, and rain fall sensors 216. The cannons 220 are configured to spray water 30 differently (e.g., in different directions and angles) based on the type of airplane 20. Moreover, the cannons 220 are adjusted to spray water 30 towards the airplane 20 and are configured to cover the entire airplane 20 with water 30. In some examples, the water cannons 220 are positioned within the taxi-on rinse deck area 202. During a rinsing routine, the cannons 220 may be elevated above the taxi-on rinse deck area 202 to spray water 30, and when no airplanes 20 are being rinsed, the cannons 220 may be hidden or lowered within the taxi-on rinse deck area 202.

In some examples, the cannons 220 receive a command from the system data processor 410 that includes a cannon position parameter to adjust a position of the cannon 220 and/or a cannon flow pattern parameter to adjust a flow pattern of the cannon 220. In some examples, the parameters are different for each cannon 220 within a rinsing zone. Moreover, the parameters may be plane dependent, i.e., the parameters depend on the type of airplane 20.

Referring to FIGS. 1C-1E, in some examples, each cannon 220 includes an actuator 224 and a controller 230 in communication with the actuators 224. The controller 230 is also in communication with the data processing device 410. The controller 230 receives a position command from the system data processor 410 and actuates the actuators 224 based on the position command to aim the fluid. In some examples, each cannon 220 also includes an adjustable nozzle 222 and a nozzle actuator 224 for adjusting the flow pattern of the nozzle 222. The controller 230 receives a spray command and actuates the nozzle actuator 224 based on the flow pattern parameter. In some implementations, each fluid cannon 220 also includes a valve 242 in fluid communication with the nozzle 222 and a valve actuator 224 that adjusts a position of the valve 242. The spray command may also include a flow rate parameter. Therefore, when the controller 230 receives the spray command, the controller 230 actuates the valve actuator 224 based on the flow rate parameter.

The nozzle 222 includes several spray states. In some implementations, the spray states of the nozzle 222 vary based on the direction in which the nozzle 222 is spraying the fluid 30. In other implementations, the spray states of the nozzle 222 may vary based on the flow rate of the fluid 30 exiting the nozzle 222. In yet other implementations, the spray states of the nozzle 222 may vary based on the shape of the fluid 30 as the fluid 30 exits the nozzle 222. The nozzle 222 includes a shaper 226 that can change the shape of the fluid 30 as the fluid 30 exits the nozzle 222. The shaper 226 may create one or more flow patterns, such as a spraying pattern, a misting pattern, a fanning pattern, a jet pattern, a shower pattern, a cone pattern, a discharging pattern, or the like.

The nozzle actuator 224 may include a tilt actuator 224a, a panning actuator 224b, a shaper actuator 224c, and/or a flow rate actuator 224d. The tilt actuator 224a defines a forward spray direction F and a vertical axis Z. The tilt actuator 224a changes the spray state of the nozzle 222 by tilting the nozzle 222 with respect to the vertical axis Z. The tilt actuator 224a may tilt the nozzle 222 within a tilt angle α, which may be centered on the forward spray direction F. The tilt angle α may be between about 30° and about 180° (e.g., between 45° and 70°). The panning actuator 224b changes the spray state of the nozzle 222 by panning the nozzle 222 about the vertical axis Z. The panning actuator 224b may pan the nozzle 222 within a panning angle β, which may be centered on the forward spray direction F. The panning angle β may be between about 30° and about 360° (e.g., between 45° and 180°).

In some implementations, the shaper actuator 224c changes the spray state of the nozzle 222 by moving the shaper 226, so that the fluid 30 exiting the nozzle 222 passes through a different shaper pattern. For example, the shaper actuator 224c can place the nozzle 222 in a misting spray state by moving the shaper 226 so that fluid 30 exiting the nozzle 222 passes through the misting pattern. Similarly, the shaper actuator 224c can place the nozzle 222 in a fanning spray state by moving the shaper 226 so that fluid 30 exiting the nozzle 222 passes through the fanning pattern. The shaper 226 may define a shaper axis S and the shaper actuator 224c may move the shaper 226 by rotating the shaper 226 about the shaper axis S defined by the shaper 226.

Referring to FIG. 1F-1I, in some implementations, the nozzle 222 includes a stem 250, a shaper collar 260, and a plunger 270. The stem 250 has a first portion 250a and a second portion 250b and defines a center axis X through the first and second portions 250a, 250b. The stem 250 defines a bore 252 along the center axis X. In some examples, the bore 252 includes a first bore 252a and a second bore 252b. The first bore 252a is in fluid communication with the second bore 252b and allows the plunger 270 to be inserted into the first and second bores 252a, 252b. In some examples, at least one conduit 254 is adjacent to the second bore 252b and allows fluid 30 to flow from the conduit 254 to the first bore 252a.

In some examples, the second portion 250b of the stem 250 defines one or multiple liquid bores or conduits 254 arranged around the second bore 252b. Each conduit 254 is in fluid communication with the first bore 252a. The conduit 254 allows the fluid 30 to flow from the supply conduit 240 removably attached to the stem 250 to the target area 150. At least one conduit 254 is in fluid communication with at least the first bore 252a.

The shaper collar 260 is movably received over the stem 250 for movement along the center axis X. In some implementations, the stem 250 defines a first threaded portion 256 adjacent to a first limit feature 258 and the shaper collar 260 defines a complementary second threaded portion 266 adjacent a second limit feature 268. The shaper collar 260 is threadably received on the first threaded portion 256 of the stem 250.

A flow distance d_{F} is a distance between a first surface 251a of an inner surface 251 of the stem 250 and the plunger 270. At a minimum flow distance d_{F} the head 272 of the plunger 270 is in contact with the first surface 251a of the inner surface 251 of the stem 250 and prevents any fluid 30 from flowing through the fluid path 30a. At a maximum flow distance d_{F} the plunger 270 is furthest from the first surface 251a of the inner surface 251 of the stem 250 and allows for the greatest fluid path 30a. A user or the nozzle actuator 224 (e.g. the flow rate actuator 220d) may adjust the flow distance d_{F} to provide a fluid path 30a of fluid 30 between 1 and 35 gallons per minute and a pressure of between 10 psi and 1200 psi.

A user 40 or the nozzle actuator 224 may adjust one or both of the angular distance d_{A} and flow distance d_{F}. A user 40 or the nozzle actuator 224 may adjust the flow distance d_{F} by rotating the plunger 270 about the center axis X (e.g., screwing the plunger 270 with respect to the threadably received stem 250). As the user 40 or the nozzle actuator 224 (e.g. the shaper actuator 224c) rotates the plunger 270 towards a forward direction F′, the flow distance d_{F} increases allowing an increase or widening of the fluid path 30a. Moreover, if the user 40 or the shaper actuator 224c rotates the plunger 270 in a backward direction B′ about the center axis X, the flow distance d_{F} decreases allowing a decrease in fluid path 30a. The shaper actuator 224c can alter the shape of the fluid 30 in the manner described above.

Additionally or alternatively, a user 40 or the nozzle actuator 224 (e.g. the shaper actuator 224c) may adjust the angular distance d_{A} by rotating the shaper collar 260 about the center axis X towards the forward direction F′ or the backward direction B′. In some examples, the shaper collar 260 is threadably received over the stem 250, and rotation of the shaper collar 260 with respect to the stem 250 causes the shaper collar 260 to move axially along the center axis X with respect to the stem 250. Movement of the shaper collar 260 towards the forward direction F′ increases the angular distance d_{A} allowing a narrower flow angle γ leading to a jet pattern, for example. Movement of the shaper collar 260 towards the backward direction B′ decreases the flow of the angular distance d_{A} allowing a wider flow angle γ leading to a shower pattern or a mist pattern, for example.

A user 40 or the nozzle actuator 224 may rotate the shaper collar 260 or the plunger 270 with respect to the threadably received stem 250. In some examples, the user 40 or the nozzle actuator 224 needs tools to rotate either the shaper collar 260 or the plunger 270. In some examples, the shaper collar 260 includes two receptacles 262 for receiving a tool (not shown) having a complementary shape to adjust the shaper collar 260, thus adjusting the flow angle γ. Additionally or alternatively, the plunger 270 may include two plunger receptacles 274 for receiving a tool (not shown) having complementary shapes to adjust the plunger 270 and control the flow rate. Therefore, a unique tool might be needed to make any adjustments to the nozzle 222, providing a tamper-proof setting, which is only adjustable by trained users 40 having the right tools. In other examples, the nozzle 222 is adjustable with tool-less features.

The flow rate actuator 224d changes the spray state of the nozzle 222 by altering the rate of flow of the fluid 30 through the nozzle 222. The flow rate actuator 224d can change the spray state of the nozzle 222 by increasing or decreasing the rate of flow of fluid 30 through the nozzle 222. The flow rate actuator 224d may include a valve, for example, a solenoid valve.

The nozzle actuator 224 may include a hydraulic actuator that includes a cylinder or fluid motor that uses hydraulic power of the fluid 30 to alter the spray state of the nozzle 222. The nozzle actuator 224 may include a pneumatic actuator that converts energy turned by compressed air at high pressure to alter the spray state of the nozzle 222. In some examples, the nozzle actuator 224 includes an electric motor. The tilt actuator 224a may use the electric motor to tilt the nozzle 222 with respect to the vertical axis Z defined by the tilt actuator 224a. Similarly, the panning actuator 224b may use the electric motor to pan the nozzle 222 about the vertical axis Z.

The controller 230 is in electronic communication with the nozzle actuator 224. The controller 230 receives wind data 350, determines a nozzle adjustment based on the wind data 350 and controls the nozzle actuator 224 to alter the spray state of the nozzle 222 based on the nozzle adjustment.

The controller 230 may include a programmable logic controller (PLC) that can be programmed in various different ways. For example, the PLC can be programmed from relay-derived ladder logic, state diagrams or state transition tables. This disclosure provides example state diagrams for programming the PLC.

In some implementations, the controller 230 can be programmed by connecting the controller 230 to the data processing device 410 (FIG. 1A) via Ethernet, RS-232, RS-485 or RS-422 cabling. In some implementations, the controller 230 includes a wireless transceiver that wirelessly receives program logic from another device. The wireless transceiver may include a Wireless Local Area Network (WLAN) transceiver, a Bluetooth transceiver, a ZigBee transceiver, a cellular transceiver, or the like. In some implementations, the controller 230 may include a processor or a microprocessor instead of or in addition to a PLC.

In some implementations, the cannon 220 includes a flow rate sensor 280 in communication with the controller 230. The flow rate sensor 280 measures a flow rate of the fluid 30 through the cannon 220. In some implementations, the flow rate sensor 280 includes a vane that is positioned inside the supply conduit 240. The vane is coupled with a wiper of a potentiometer. As fluid 30 passes through the supply conduit 240, the fluid 30 pushes the vane, which moves the wiper and changes the resistance of the potentiometer. The flow rate sensor 280 sends the flow rate to the controller 230.

FIG. 1D illustrates a perspective view of the cannon 220. The cannon 220 includes an articulated supply conduit 240 that receives fluid 30 from a fluid source (not shown) that the cannon 220 sprays through the nozzle 222. In the example shown, the articulated supply conduit 240 includes a first supply conduit 240a and a second supply conduit 240b. The first supply conduit 240a delivers a first fluid 30a to the cannon 220 and the second supply conduit 240b delivers a second fluid 30b to the cannon 220. For example, when the cannon 220 is used to rinse airplanes 20, the first supply conduit 240a can import water 30 and the second supply conduit 240b can import liquid soap. In another example, when the cannon 220 is used in firefighting, the first supply conduit 240a can import water 30 and the second supply conduit 2401) can import liquid foam.

The cannon 220 includes a supply conduit valve 242. The supply conduit valve 242 controls the flow rate of the fluid 30 through the supply conduit 240. Although, in the example shown, the supply conduit valve 242 is positioned to control the flow rate of the second supply conduit 240b, in other implementations, the supply conduit valve 242 may be positioned to control the flow rate of the first conduit 240a, the second conduit 240b, or both the first conduit 240a and the second conduit 240b. The controller 230 controls the position of the supply conduit valve 242 to adjust the flow rate of the fluid 30, 30a, 30b through the supply conduit 240.

FIG. 1E provides a perspective view of the cannon 220 spraying fluid 30 through the nozzle 222. The cannon 220 is spraying the fluid 30 onto a target area 150 (e.g., airplane 20). The controller 230 directs the fluid 30 onto the target area 150 by controlling the spray state of the nozzle 222. For example, the controller 230 may adjust the tilt angle α and/or the panning angle β of the nozzle 222 so that the nozzle 222 sprays the fluid 30 in the same direction as the target area 150. The controller 230 may also adjust the flow rate of the fluid 30 by adjusting a position of the supply conduit valve 242, so that the fluid 30 reaches the target area 150. In the example shown, the supply conduit valve 242 is integrated into the supply conduit 240. Other details and features combinable herewith can be found in U.S. patent application Ser. No. ______, filed ______, which is hereby incorporated by reference in its entirety.

In some examples, the rinsing system 200 is a wet washing system for removing oil, grease, or carbon deposits and most soils and salt. If cleaning compounds are used, the cleaning compounds are applied by a spray or mop, and high pressure running water 30 is used to rinse the cleaning compounds of the airplane 20.

The rinsing system 200 may apply cleaning agents to the surface of the airplane 20. Different cleaning agents are available for different purposes, for example, a different cleaning agent may be used to remove salt than one to remove dirt. Soap and synthetic detergent type cleaners may be used for light duty cleaning, and solvent and emulsion type cleaners may be used for heavy duty cleaning. Only cleaners that can be effectively rinsed and neutralized are used on airplanes 20, otherwise the cleaner might cause corrosion within the lap joints of riveted or spot-welded sheet metal components of the airplane 20 outer surface. In some implementations, it is preferable to wash the airplane 20 in the shade to avoid streaks on the surface of the airplane 20 caused by the cleaning agents due to a hot surface or if the cleaning agents are allowed to dry on the surface.

The rinsing system 200 may include a washing sensor system 210 that includes multiple sensors 212 disposed throughout the taxi-on rinse deck area 202. The sensors 212 may automatically detect an object on the taxi-on rinse deck area 202 and initiate a rinse routine. In some examples, the taxi-on rinse deck area 202 defines multiple rinse zones, where a different rinsing routine is associated with each rinse zone. The sensors 212 may track the airplane 20 as it moves along the taxi-on rinse deck area 202 and trigger a different rinsing routine depending on the location of the airplane 20 on the taxi-on rinse deck area 202.

The filtration system 300 may be a water recycling system. The taxi-on rinse deck area 202 includes water drains for capturing the water used to rinse an airplane 20. The filtration system 300 monitors the total dissolved solids (salts). When the total dissolved solids reach a threshold limit (high limit) the filtration system 300 discharges the water into a waste tank. In some examples, up to 80% of the water used for rinsing an airplane 20 is recycled. As an example, if 12 airplanes 20 are washed each day for 250 days a year, then the filtration system 300 saved about 520 gallons per minute of 1,500,000 gallons of water per year.

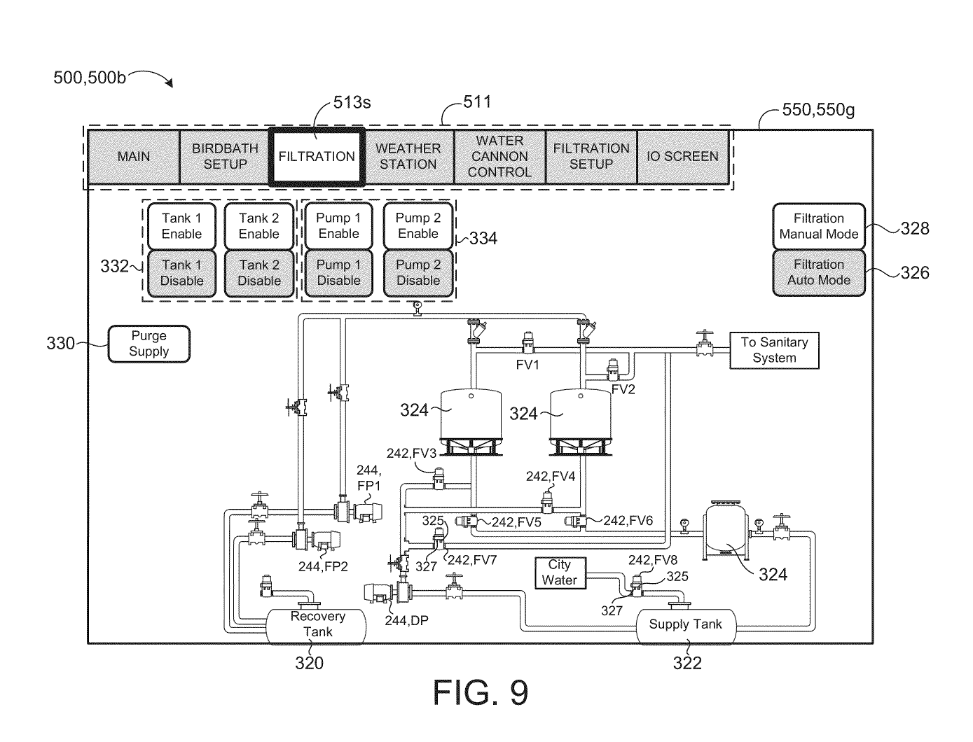

The filtration system 300 may include water tanks 302 used for collecting and filtering the water used for rinsing the airplanes 20. The filtration system 300 includes valves FV1-FV8 (discussed below with respect to FIG. 9), where each valve includes a valve actuator 325 and a valve controller 327. The valve controller 327 (behaving similarly to the valve controller 242 of the rinsing system 200) receives a command from the system data processor 410 of a valve position and the actuator 325 actuates the valves FV1-FV8 based on the command received from the system data processor 410. The valves FV1-FV8 control the flow of the water within the filtration system 300.

The system data processor 410 (e.g., computing device) includes a non-transitory memory 412. The system data processor 410 provides the user 40 with the user interface 500 allowing the user 40 to enter information communicated via the network 10 to the rinsing system 200 and the filtration system 300. The system data processor 410 executes a specific rinsing routine and filtration routine based on the user selection. The system processor 410 stores on its non-transitory memory 412 (or on the cloud memory 14) pre-determined configurations for each airplane 20 that may be provided to the user 40 as a selectable option.

The user interface 500 executes an application 110 displayed on a display 420 (e.g., touch-screen or non-touchscreen). If the display 420 is not a touch-screen display 420, then the user interface 500 includes a keyboard and/or a mouse in communication with the processor 410 to allow a user 40 to input data or make a selection based on parameters provided on the display 420.

Referring to FIG. 1B, in some implementations, the system data processor 410 allows the washing system 100 to initiate a rinsing routine upon a user's selection of an airplane type. The system data processor 410 is in communication with the rinsing system 200 and the filtration system 300.

The user interface 500 may include two interfaces: an untrained user interface 500a; and a trained user interface 500b. The untrained user interface 500a allows an untrained user 40 to make a selection of a type of airplane 20 and the system 100, based on the selection made by the untrained user 40, determines a rinsing routine of the rinsing system 200 and a filtration routine of the filtration system 300. The trained user interface 500b includes a system configuration interface 502 and a system monitoring interface 504. The system configuration interface 502 allows a trained user 40 to configure the wash system 200 and the filtration system 300 for each airplane type, while the system monitoring interface 504 allows the trained user 40 to monitor values of the washing sensor system 210 and the filtration sensor system 310.

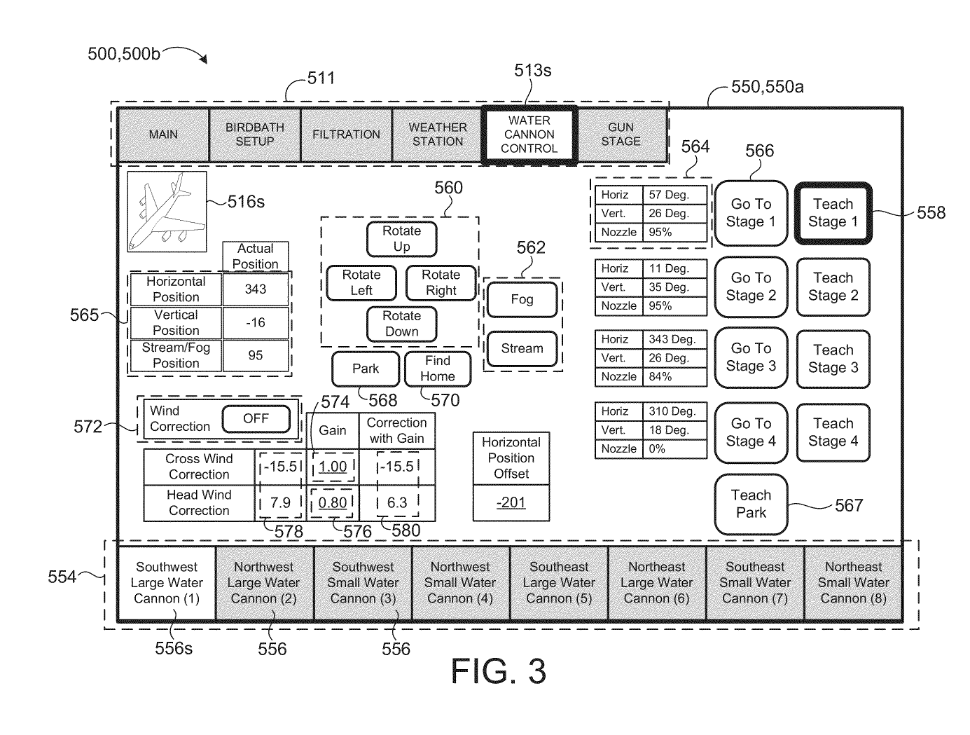

In some implementations, a trained user 40 utilizes the user interface 500 to configure specific airplane types using the system configuration interface 550 (FIG. 3). The configuration settings may be stored on non-transitory memory 412 of the processor, or in some examples, may be stored on the user interface non-transitory memory, or the cloud storage 14. The trained user 40 may execute an application 110 to run a rinsing routine based on the configured settings. During the rinsing routine, the system data processor 410 receives sensory data from the washing sensor system 210 and the filtration sensor system 310 and displays the sensor data on the display via the trained user system monitor interface 550. Once the trained user 40 completes the system configuration 502, an untrained user 40 may select an airplane type from a list of airplanes 20 whose configurations are predetermined by the trained user 40. Once the system 100 receives the user selection, the system 100 begins washing the airplane 20. The trained user 40 may monitor the performance of the rinsing system 200 and the filtration system 300 and adjust the configuration of the rinsing system 200 and/or the filtration system 300 (discussed below).

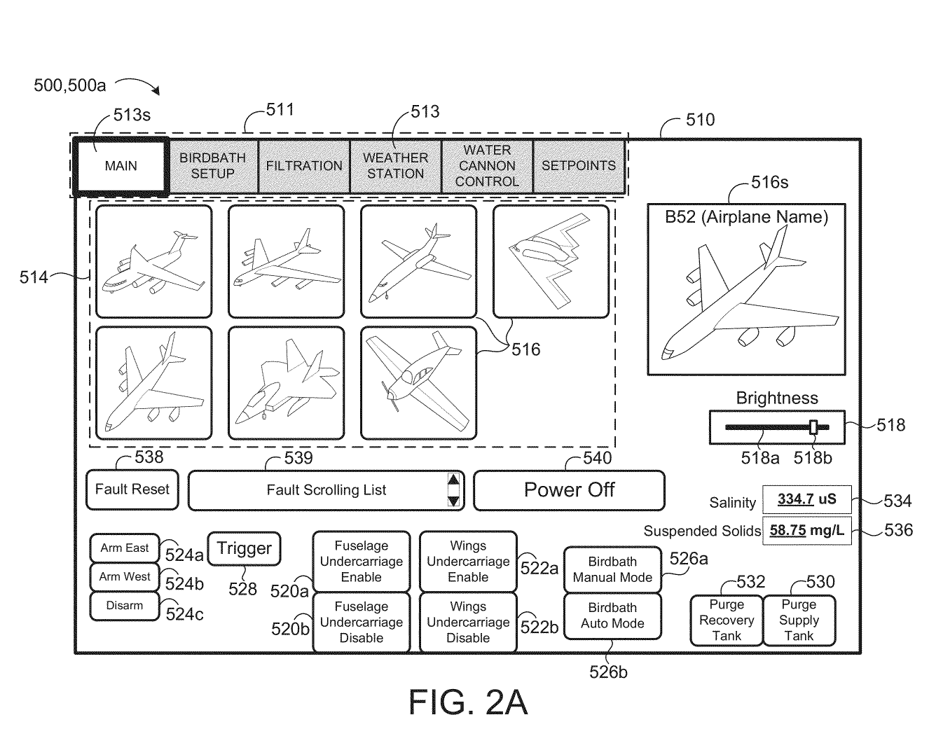

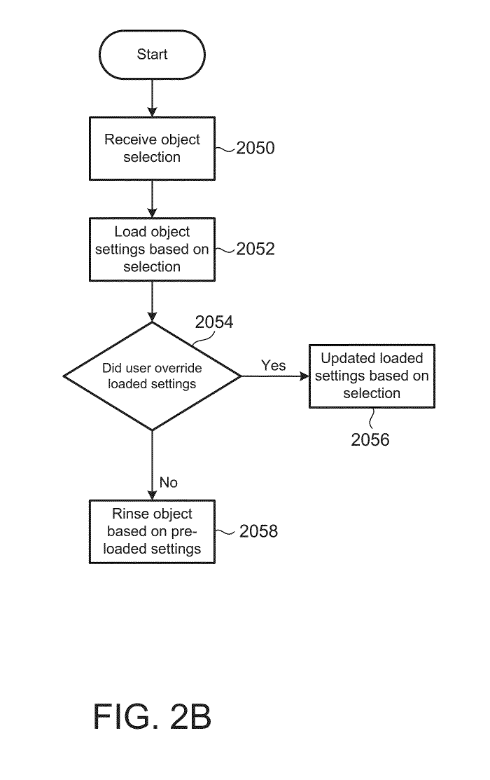

The user interface 500 includes an untrained user interface 500a (FIG. 2A) and a trained user interface 500b (FIG. 3). Referring to FIG. 2A, a main screen 510 of an untrained user interface 500b allows a user 40 to select an airplane type from a grid 514 of airplane images or icons 516 (or list of airplane names), and based on the user selection 516s of the airplane type, the washing system 100 performs functionalities specific to the selected airplane 516s. As shown on the main screen 510 of the untrained user interface 500b, the selected airplane 516s may be shown on the top right corner to indicate the selection made by the user 40. The selected airplane 516s may be shown in other locations on the screen 510. In other examples, the system 100 may highlight the selection 516s or change the appearance of the selected airplane 516s within the grid 514 of airplane icons 516 to differentiate between the selection 516s and the non-selected airplane icons 516. The functionalities of the specific airplane 20 are pre-configured by a trained user 40 (discussed below). The user 40 may select the type of airplane 20 by using a mouse or touching the screen specifically on the airplane icon 516. Once the user 40 makes the selection, the selected airplane 20 will show in the selection window 516s of the main screen 510.

In some implementations, the main screen 510 includes a brightness feature 518 that allows the user 40 to adjust the brightness of the display 420. In some implementations, the brightness adjustment feature 518 is a sliding bar 518a with an indicator 518b that indicates the brightness of the display 420. In some examples, the brightness feature 518 is a percentage or a value that the user 40 may manually change or may increase or decrease using arrows (displayed on the main screen 420510 or on a keyboard). The main screen 510 may also include a time and date window for indica the current time and the current date.

Although the system 100 limits adjusting the system configurations to the trained user 40, the system 100 may provide some configurable features to the untrained user 40. Therefore, in some examples, the fuselage undercarriage of an airplane 20 may include expensive equipment, such as radar dome or an expensive camera. The user 40 may be aware of such expensive equipment on the fuselage undercarriage and to avoid any damage to the equipment, the user 40 may disarm a spray bar that sprays water towards the fuselage undercarriage only. A fuselage undercarriage enable button 520a and a fuselage undercarriage disable button 520b are available. In some examples, the fuselage undercarriage enable button 520a is enabled when the user 40 selects the airplane type, and the user 40 can later disable the fuselage undercarriage button 520b only when the user 40 determines that the airplane 20 is carrying expensive machinery. In other examples, the fuselage disable button 520b is enabled (i.e., the system 100 will not spray the undercarriage of the airplane 20) when the user 40 selects the airplane type. Similarly, the expensive equipment may be located on the wings undercarriage, and the system 100 can be enabled or disabled by the enable and disable wings undercarriage buttons 522a, 522b. Therefore, the user 40 may override the preconfigured settings by enabling or disabling the undercarriage water cannons 220. As shown, there are separate enable and disable buttons (e.g., for the fuselage undercarriage and wings undercarriage), but other buttons may also be available, such as a radio button, toggle buttons, an on/off button, or any other indicator capable of indicating that the user 40 can enable and disable the undercarriage cannons 220.

In some implementations, the user 40 may select the position from which the airplane 20 will approach the taxi-on rinse deck area 202, such as from the east side of the taxi-on rinse deck area 202 or from the west side of the taxi-on rinse deck area 202 (or from the north side or south side of the taxi-on rinse deck area 202, depending on the position of the taxi-on rinse deck area 202). The user 40 may determine the position by which the airplane 20 approaches the taxi-on rinse deck area 202 by selecting from a list of available selections, for example, arm east 524a, arm west 524b, arm north, or arm south. In addition, in some implementations, a disarm button 524c may be available to the user 40 for disabling the detection of the position by which the airplane 20 approaches. In some examples, the buttons 524a, 524b, 524c are not available since the system 100 auto-detects the position that the airplane 20 approaches the taxi-on rinse deck area 202.

Moreover, in some implementations, the user 40 may select between a manual mode 526a and an auto mode 526b. When the user 40 selects the manual mode 526a, then every time an airplane 20 is about to approach the taxi-on rinse deck area 202, the user 40 has to select the airplane type from the grid 514 of airplane images or icons 516 (or list of airplane names), then the user 40 selects the position from which the airplane 20 is approaching the taxi-on rinse deck area 202. Finally, the user 40 selects a trigger button 528 to activate the rinsing system 200 and the filtration system 300. When the user 40 selects the auto mode 526b, then the user 40 eliminates the need to select the trigger button 528 when the airplane 20 is about to approach the taxi-on rinse deck area 202 because the system 100 (using sensors located on the taxi-on rinse deck area 202) detects when the airplane 20 is on the taxi-on rinse deck area 202 and automatically triggers the rinsing system 200 and the filtration system 300. Therefore, the main difference between a selection of the manual mode button 526a and the auto-mode selection 5261) is that in the manual mode 526a the user 40 triggers initiation of the washing/filtrations routine, while in the automatic mode, the user 40 becomes less proactive and eliminates the use of the trigger button 528 since the system 100 automatically detects the airplane 20 and automatically initiates the washing/filtration. In some implementations, when the automode is selected, the system 100 notifies the user 40 once the system 100 detects an airplane 20 and from which side the airplane 20 is approaching the taxi-on rinse deck area 202.

When the user 40 arms the system 100, the system 100 activates the rinsing system 200 opening valves to release water into the tubes. The water is initially released at low pressure and when the user 40 selects the trigger button 528 or when the system 100 is automatically triggered (in auto-mode 526b), the valves release the water at full pressure. This mechanism of releasing water into the pipes 17 at a lower pressure before releasing the water at full pressure is advantageous because it allows the system 100 to gradually increase its water capacity within the tubes before blasting out the water at full pressure. The disarm button 524c allows the user 40 to disarm the selection made between the arm east button 524a or the arm west button 524b. During the arming stage, valves are slowly opened and the pressure is slowly increased until full pressure is achieved when the airplane 20 reaches the washing system 100.

In some implementations, when a user 40 selects the auto-mode 526b, the system 100 detects a type of airplane 20 as it approaches the taxi-on rinse deck area 202 and based on that determination, selects the corresponding wash and filtration routines. Additionally, the system 100 may automatically detect from what direction the airplane 20 is approaching the taxi-on rinse deck area 202. In such cases, the system 100 becomes autonomous since it does not need any user 40 involvement.

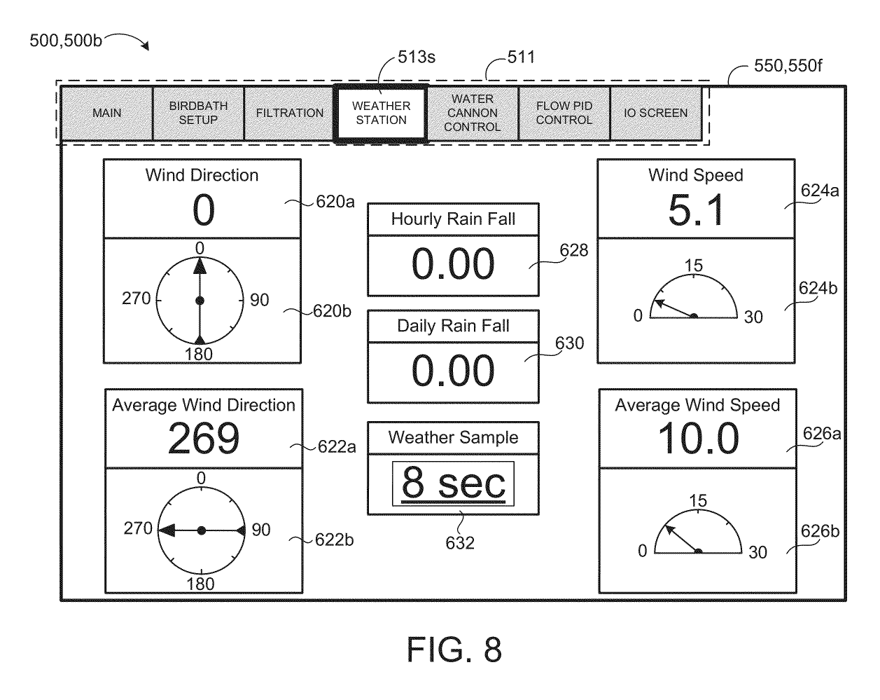

In some implementations, the main screen 510 includes a weather station tab 513, which when selected by a user 40 provides the current weather and a prediction of the weather (see FIG. 8). The rinsing system 200 includes a supply tank 322 (see FIG. 9) and a recovery tank 320 (see FIG. 9). The supply tank 322 receives water, for example, from the city, and provides clean water to clean the airplane 20. Each tank 320, 322 includes a sensor for measuring the salinity of the water and another sensor for measuring the suspended solids in the water tank 320, 322. The salinity is the salt content dissolved in the water contained in the tank 320, 322. The suspended solids in the water refer to small solid particles that remain in suspension in the water as a colloid or due to the motion of the water within the tank 320, 322. The suspended solids measurement is used as an indication of the quality of the water. The main screen 510 may include a measurement of the salinity 534 of the water in the tanks 320, 322 and a measurement of the suspended solids 536 of the water in the tanks 320, 322. Therefore, based on the salinity value 534 and the suspended solids value 536, the user 40 may want to purge one or both tanks 320,322, especially if the weather station indicated that there may be precipitation, which would cause the tanks 320,322 to fill up. The system 100 may have a preconfigured threshold salinity value and a preconfigured suspended solids threshold value, where if the current value of one or both the salinity value 534 or the suspended solids value 536 is over the predetermined threshold value, then the system 100 prevents the rinsing system 200 from washing the airplane 20.

Therefore, if the user 40 determines that there may be rain precipitation, the user 40 may select to purge the supply tank 322 by selecting the purge the supply tank button 530 to refresh the water in the tank 322 because as more airplanes 20 are being washed, more salt is built in the supply tank 322. In addition, if the level of salt or dirt gets to a predetermined level, the user 40 may purge the supply tank 322.

In some implementations, the system 100 may experience a system error. The system 100 may indicate on the display 420 that an error has occurred. The errors may be displayed in a scrolling list 539 on the main screen 510. The user 40 may select a fault reset button 538 for resetting any faults that the system 100 may have experienced. The fault reset button 538 is disabled and may not be selected by the user 40 unless a fault has occurred.

In some examples, the user 40 may turn off the system 100 by selecting a power off button 540. The power off button 540 may turn off the display 420 of the user interface 500, or may turn off the system 100 including the rinsing system 200 and the filtration system 300.

Referring to FIGS. 2A and 2B, in some implementations, the system 100 the processor 410) receives an airplane 20 or an object selection at block 2050. The airplane selection includes a type of airplane 20. Each type of airplane 20 is associated with pre-configured configurations 414 based on the airplane type and size. The pre-configured setting 414 are stored in the non-transitory memory 412. When the user 40 makes the selection of the airplane 20, the system 100 retrieves the stored configurations 414 from the non-transitory memory 412 at block 2052, in order to execute a washing routine. In some examples, the user 40 may override some predetermined configurations 414, such as the ones discussed above, e.g., disabling the fuselage undercarriage sprayers. If the user 40 overrides the loaded setting, block 2054, then the system 100 executes the washing routine with the user settings at bock 2056. However, if the user 40 has not made any modifications to the configurations, then the system 100 executes the washing routine with the preconfigured configurations at block 2058.

In some implementations, the main screen 510 includes a group of tabs 511 having multiple tabs 513. Each tab 513 represents a screen 550, e.g., the main screen 510, a setup screen 5506, a filtration screen 550g, a weather screen 550f, and a water cannon control screen 550a. When one of the screens 550 is selected, e.g., the main screen tab 513s changes in appearance to indicate that the main screen 510 is being displayed. FIGS. 3-10 are screen shots accessible by trained users 40 to configure and adjust the settings 414 for each of type of airplane 20, which later allows an untrained user 40 to select an airplane 20 and the system 100 automatically starts rinsing the airplane 20.

FIG. 3 shows a water cannon control tab 513s only available to trained users 40. The water cannon control tab 513s, when selected displays a water cannon control screen 550a, which allows the trained user 40 to set up how the rinsing system 200 rinses the airplane 20.

In some implementations, the system 100 divides the washing routine into stages, where each state is configured to spray and rinse a different portion of the airplane 20 as the airplane 20 passes through the taxi-on rinse deck area 202. The trained user 40 selects a length of time for each stage, the position of the cannons 220 (e.g., horizontal, vertical, and stream/fog position of the cannon 220) and whether the cannons 220 should be adjusted based on the wind direction or speed.

As shown, the trained user 40 may configure the water cannons 220 used to rinse the airplane 20. In some examples, the system 100 includes multiple water cannons 220 and each is independently configurable. As shown at the bottom of FIG. 3, the system 100 includes eight water cannons 220 each represented by a tab 554 and each one is configured independently from the other. A user 40 may select a cannon 220 to configure from the list of cannons 220.

As shown in the figure, a picture of the current airplane 516s whose settings are being configured is shown on the current screen 550a. The selected cannon 516s is the southwest large water cannon 220, which is being configured. The user 40 may select where the water cannon 220 sprays and the spray pattern and where each cannon 220 will spray in each of the four stages.

When a trained user 40 configures the settings of each water cannon 220, the user 40 selects the tab 556s of the respective cannon 220 to be configured. In some examples, the washing routine is divided into four stages, each stage having a predetermined time (sometimes adjustable or selectable by the user 40). Therefore, the user 40 can configure each stage separately from the other stages. The user 40 selects the stage to be configured. For example, the user 40 may select to teach a stage by selecting a teach stage 1 button 558. Once the teach stage button 558 is selected, the user 40 may adjust the cannon 220 by rotating it up, down, right, or left using direction buttons 560. In addition, the user 40 may select the pattern of the cannon 220 by selecting one of the pattern selection buttons 562, e.g., fog or stream patterns. Other patterns may also be available. The values of the cannon 220 are shown for each stage in the value portion 564. When the user 40 determines the settings of a stage, the user 40 may select the go to stage 1 button 566, which enables the cannon 220, and the user 40 can visually see the settings he or she configured. In addition, the actual position of the cannon 220 is shown on the display 420 in an actual position window 565.

In some implementations, the system 100 includes a park position button 568. The park position button 568 lowers the cannons 220 into a low position within a pit that each cannon 220 is installed in. The park position button 568 is used when a user 40 wants the cannons 220 to be within a predefined height in their unused state. The user 40 may teach the cannons 220 to be in a parked position within a specific stage. For example, a user 40 may select a teach park button 567 and determine the position of the cannons 220 and their height within the pit that houses the cannons 220. The user 40 has to teach each cannon 220 a park position using the teach park button 567, because after the rinsing routine is complete, all the cannons 220 go to the park position before it is time for another airplane 20 to be washed.

In some implementations, the system 100 includes a find home button 570 that resets the movement of the cannon 220 when the cannon position is no longer in sync with the position that the system 100 is reading. Therefore, the system 100 can re-calibrate the cannon position and re-sync the position with the reading position. This may occur when the system 100 loses power for examples.

In some examples, the system 100 includes wind sensors 214 for measuring the wind speed and direction. The system 100 may consider the measurements of the wind speed and direction and adjust the position of the cannons 220 accordingly. The user 40 may have to enable the wind correction button 572. In some examples, the user 40 may specify a gain value for each of the cross wind correction 574 and a gain value for the head wind correction 576. The system 100 displays the actual values 578 of the cross wind and the head wind, and also displays the corrected values 580 based on the gain values 574, 576 inputted by the user 40. If the user 40 enters the value “0” as the gain values 574, then the system 100 does not auto correct the portion of the cannons 220 when the wind sensors determine that there is wind. Since the wind correction is associated with each cannon 220, each cannon 220 may have different wind correction values 574, 576 for each stage. In some examples, each water cannon 220 may have a gain value different than another water cannon 220. Moreover, each water cannon 220 may have a gain value in one stage different than the gain value in another stage. Usually, a trained user 40 may configure the system 100 in calm winds, and then the user 40 determines if he or she wants to enable the cross wind correction.

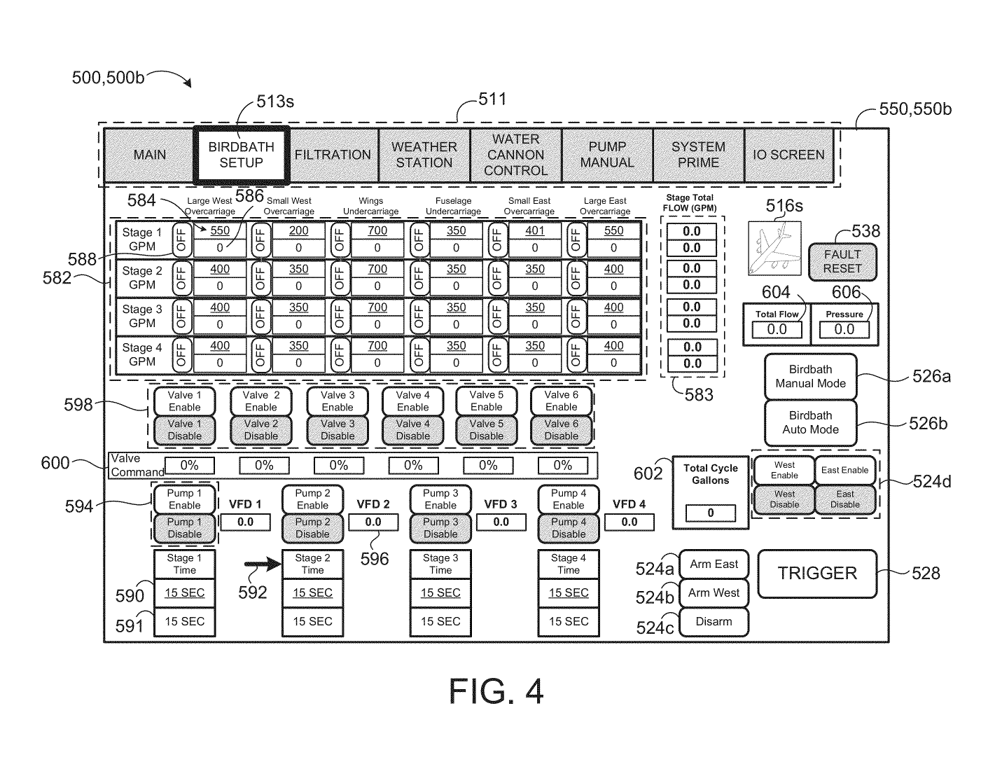

Referring to FIG. 4, in some implementations, the user 40 may program the flow of the water per stage per airplane 20 part via the setup screen 550b. A flow window 582 allows the user 40 to enter a number of gallons of water 584 that the rinsing system 200 can use during a stage. In some examples, the user 40 may specify a number of gallons of water 584 that the user 40 can use on a specific part of the washable object, e.g., the large west or small west overcarriage of an airplane 20. If the user 40 runs a rinsing routine, the user interface 500 displays a number of gallons per minute (GPM) 586 that are being used during the rinsing routine. Moreover, if the user 40 decides not to disable or not use water during a stage, then the user 40 can either enter a value of zero when specifying the number of gallons of water 584 or can select an off button 588 to indicate that no water should be outputted during the specific stage. In addition, in some examples, the user interface 500 displays, based on a calculation by the processor 410, in the total flow window 583, a total number of gallons used for stage and a number of gallons per minute used for each stage.

The setup screen 550b allows the trained user 40 to select a time 590 for the rinsing routine or for each stage. As shown in FIG. 4, a user 40 may specify a length of time 590 for each stage of the washing routine. In addition, if the rinsing system 200 is executing a rinsing routine, the user interface 500 displays the time remaining 591 to complete the rinsing routine. The time remaining 591 may be a counter counting until it equals the length of time 590 for each stage, or the counter begins with a time equal to the length of time 590 of the stage and counts down till zero. The user interface 500 may display an indicator 592 (e.g., an arrow) to indicate at which stage the system 100 is executing.

In some implementations, the setup screen 550b allows the trained user 40 to select between a manual mode 526a and an auto mode 526b (previously discussed in FIG. 2A). In addition, the trained user interface 500 displays an arm east button 524a, and arm west button 524b, and a disarm button 524c also similar to the buttons available to the untrained user 40 (previously discussed in FIG. 2A). Additionally, the user interface 500 gives the trained user 40 an option to enable or disable sensors that detect from which side of the taxi-on rinse deck area 202 the airplane 20 is approaching using the enable/disable features 524d. The trained user interface 500 may also have a fault reset button 538.

The setup screen 550b may allow the trained user 40 to enable or disable certain pumps using an enable/disable feature 594. The pumps may be for the rinsing system 200 or the filtration system 300 or a combination of both. As shown, the system 100 includes four pumps, but other numbers of pumps are also available. In some example, the screen 550b displays the variable-frequency drive 596, which is the speed of the motor of the pumps.

In some examples, the user interface 500 displays a valve 242 enable or disable feature 598. The trained user 40 may select which valves 242 to enable or disable. The system 100 may include one or more valves 242. As shown the system 100 includes six valves 242. The user interface 500 may display a valve command window 600 for informing the trained user 40 of the number or percentage of valves 242 that are enabled and are supplying the water.

In some examples, the user interface 500 informs the trained user 40 of a total flow of water 604 and the pressure 606 at which the water is flowing. The user interface 500 may also display the total number of gallons 602 used in a rinsing routine.

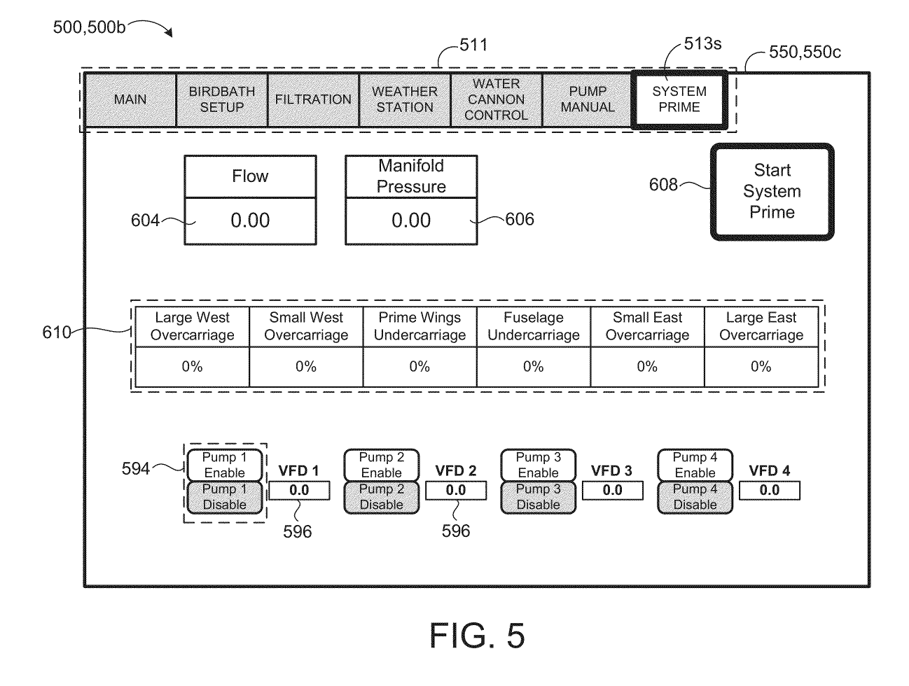

Referring to FIG. 5, the user interface 500 shows the system prime screen 550c. In some instances, the pipes 17 (shown in FIG. 1A) of the rinsing system 200 are fully drained. After draining the rinsing system 200 completely, it is recommended to slowly fill the pipes 17 with fluid instead of blasting the fluid at full pressure in the pumps 244, especially if the pipes 17 are filled with air. The system prime screen 550c allows the system 100 to initiate before executing a rinsing routine. A trained user 40 may initiate a system prime procedure by selecting a start system prime button 608. Once the trained user 40 selects the system prime button 608, the pumps 244 start finning slowly and each of the valves (e.g. 6) will open to (15%) till the sensors start showing water, which allows the pipes to run slowly and the valves to slowly open allowing the water to flow slowly before flowing at 100% capacity. A trained user 40 might use the screen 500c to perform maintenance on the system hardware without the system functioning at full capacity. If the pipes 17 are full of air, it is dangerous to fill them up at full speed. Referring to the water sensor window 610, in some examples, one or more sensors are placed within the pipes 17 to detect if water is flowing through the pipes 17. The sensor may indicate a percentage of water flowing through each valve.

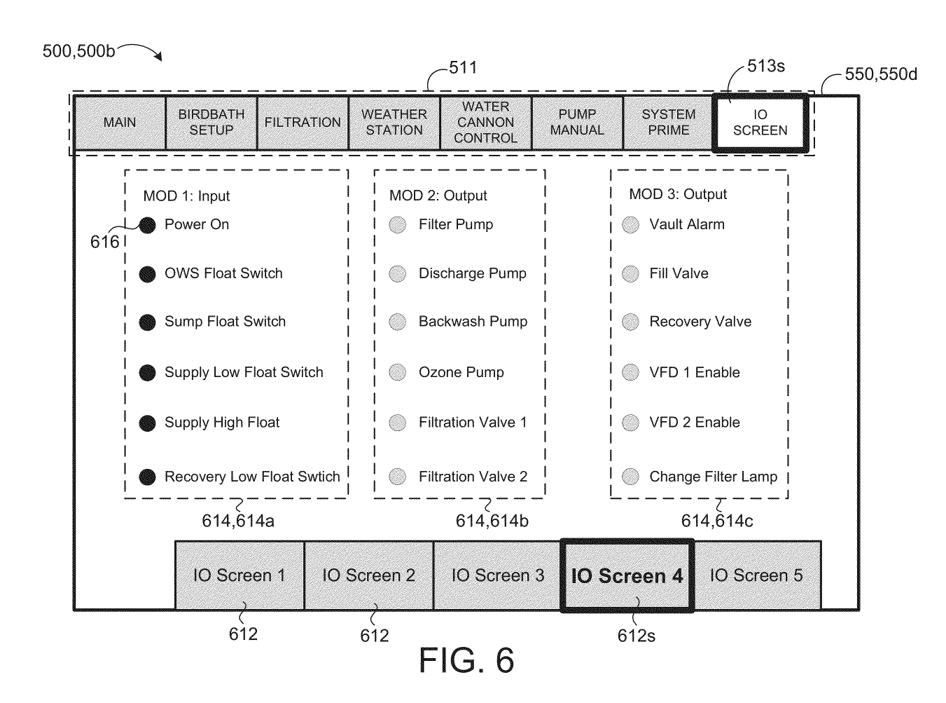

FIG. 6 shows an input/output screenshot 550d that displays information to the trained user 40. This input/output screen 550d provides an overview of the system 100 as a whole and helps the trained user 40 diagnose the system 100 to determine which part of the system 100 may be undergoing a fault or failure. In some examples, the display 420 does not fit all the features that the user interface 500 wants to display; therefore, the user interface 500 divides the displayed features into separate pages 612. The trained user 40 may access each page 612 of the input/output screen 550d by selecting one of the tabs at the bottom of the screen 550d. As shown, the system 100 includes 5 pages 612 of input/output screens, however, other systems 100 may need more or less pages 612. As shown, page 4 of the input/output screen is the selected page 612s.

As shown, the IO screen displays three columns 614, 614a, 614b, 614c, each having one or more features capable of being monitored. Other numbers of columns 614 may also be displayed, and in some examples, the features may be arranged in rows instead of columns. In addition, the user interface 500 may organize the features based on whether they are an input feature or an output feature. For example, referring to the first element in the first column 614a, if the power is on an indicator 616 changes e.g., from red to green. MOD 1 column 614a represents the inputs of the system 100, and MOD 2 and MOD 3 columns 614b, 614c represent the outputs of the system 100.

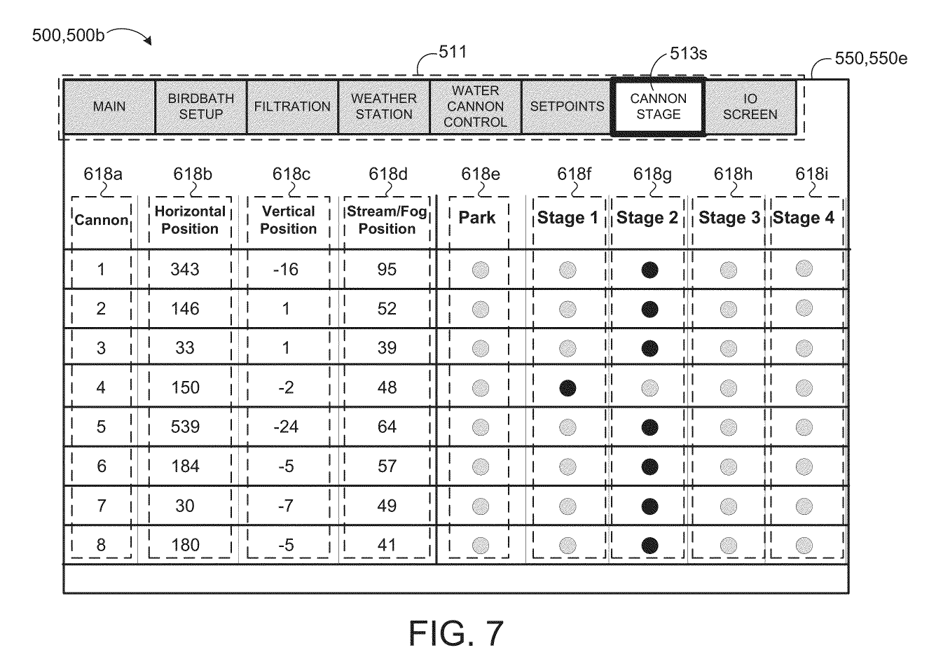

Referring to FIG. 7, a cannon stage screen 550e is shown. The cannon stage screen 550e is also an information only screen 500e since it displays information relating to the system 100 or portions of the system 100 and does not allow the trained user 40 to interact with the screen 550e. The cannon stage screen 550e provides a status and a position of each water cannon 220 of the rinsing system 200 and at what stage of the washing routine the water cannon 220 is releasing the fluid. For example, a first column 618a displays the cannon number, a second column 618b displays the horizontal position of the cannon 220, a third column 618c displays the vertical position of the cannon 220, a fourth column 618d displays the fluid pattern that the cannon 220 is releasing as a percentage. The horizontal position, vertical position and the stream/fog position values are the same as the values shown in window 565 in FIG. 3.

Moreover, columns 5 through 9 indicate at which stage, i.e., park or stages 1-4, the cannon 220 is releasing water. In cases where there are no failures, the indicators for each cannon 220 of the first column 618a are all in one stage and then the indicators move simultaneously through the stages. However, as shown in the figure, all the cannons 220 are executing the release of the water as specified by the user 40 in FIG. 3, but cannon 4 has not transitioned to stage 2 like the rest of the cannons 220, therefore, the system 100 detects that cannon 4 is experiencing a fault or a malfunction.

Therefore, as the system 100 is running in stage 1, the indicators in stage 1 change to green or any other color. When the system 100 continues to stage 2, the stage 2 indicators change to green or any other color. If one of the cannons 220 fails, the failed cannon 220 might not move to a subsequent stage, indicating a fault in the system 100 and allowing diagnosis of a problem. This screen 550e provides a quick way to diagnose a problem when the system 100 is running.

As previously mentioned, in some implementations the system 100 includes wind speed and wind direction sensors 214. Additionally, the system 100 includes a rain sensor 216 for determining an amount of rainfall. Referring to FIG. 8, a weather station screen 550f displays information received from the sensors. As shown, a window for wind detection shows a digital indicator 620a of the wind direction and an analog indicator 620b. The system 100 may also determine an average wind direction and the user interface 500 displays the determined average wind direction as a digital indicator 622a or an analog indocator 622b. Similarly, another window shows a digital indicator 624a for the wind speed and an analog indicator 624b for the wind speed. Moreover, the system 100 may determine an average wind speed and the user interface 500 displays the determined average wind speed as a digital indicator 626a or an analog indicator 626b.

Moreover, the user interface 500 displays the hourly rain fall value 628 and the daily rain fall value 630. The weather station screen 550f allows the trained user 40 to determine a threshold period of time for the system 100 to retrieve the sensor information and calculate the average values. For example, as shown the user 40 entered 8 seconds as the value in window 632, therefore, every 8 seconds the system 100 retrieves the information from all the sensors and determines the average wind direction and speed. The trained user 40 may configure the frequency of how often the sensors should take those measurements.

Referring to FIG. 9, a filtration screen 550g is shown (maintenance screen). The washing system 100 is configured to wash an airplane 20, filter the water used while washing the airplane 20, and reuse the water to wash another airplane 20. The filtration screen 550g provides an overview of all the equipment of the filtration system 300. A recovery tank 320 and a supply tank 322 are shown in the filtration screen 550g. In some examples, the user interface 500 may display an amount or percentage of water remaining in each of the tanks 320, 322. Moreover, each tank 320, 322 may include a high and a low float inside each of the tanks 320,322, each float having a sensor that communicates with the system 100. If a tank 320, 322 is full, then both floats should provide a positive feedback (green). However, if the tank 320, 322 is full and the system 100 is only receiving a positive feedback (green) from the high float, then the low flow is at fault.

The filtration screen 550g includes a representation of fill valves FV1-FV8. The trained user 40 may select one or more of the fill valves FV1-FV8 and open or close the valve FV1-FV8. Similarly, the trained user 40 may select one or more of the pumps 244 i.e., a first fill pump FRI, a second fill pump FP2, or discharge pump DP, and open or close the pums FP2, DP. For example, a trained user 40 may want to close one or more valves FV1-FV8 and open one or more pumps FP1, FP2, DP. In some examples, the valve representations and the pump representations may have a red color when they are closed and a green color when they are open, which provides the trained user 40 with a better visual and indication of which pumps 244 and valves 242 are open or closed.

The filtration system 300 includes a filtration tank 324. The filtration tank 324 receives the used water from the rinsing system 200 through drains into a recovery tank 320 and filters the water before routing the water back to the supply tank 322. When the water is in the recovery tank 320, filter pumps FP1, FP2 will run forcing the water to move to the filters tank 324 and finally the water reaches the supply tank 322.

In some examples, the filteration tank 324 uses a media filter, which is a type of filter that used a bed of dan, crushed granite or other material for filtering the water. Other filtration methods may also be used. In some examples, each filter tank 324 may include a pressure sensor (not shown) for the water entering the tank 324 and another pressure sensor for the water outputed from the filtration tank 324. The sensors are useful for determining if a drop in water pressure has occurred, which indicates that the filter may be clogged up. A drop in pressure indicates that water is hardly flowing through the filter, then the system 100 may trigger a fault.

The system 100 may include two filtrations modes: a filtration manual mode and a filtration auto mode. The trained user 40 may select the filtration auto mode button 326 or the filtration manual mode button 328. The filtration auto mode button 326 allows the filtration system 300 to automatically filter water when water is received in the recovery tank 320, or when the recovery tank. 320 is at a threshold value of water.

In some examples, if the supply tank 322 does not have enough water, the trained user 40 may fill the supply tank with city water by opening a valve FV8.

In some implementations, the trained user 40 may select different filtration modes. Moreover, the trained user 40 may decide to empty the supply tank 322 and can do so by selecting a purge supply button 330. A purge recovery tank may also be available to allow the trained user 40 to empty the recovery tank 320.

The filtration screen 550g may also allow the trained user 40 to enable or disable specific tanks 320, 322 in the window 332 or enable or disable specific pumps in the window 334. Moreover, each filter tank 324 may include a life remaining indicator for indicating the remainder of the life of the filter tank 324.

In some implementations, a filtration setup screen (not shown) includes a setup for determining multiple timers, such as the time of each pressure reading, the time at which the titter pump may be configured, the time at which the system 100 determines that the valve for city water needs to be opened so that the supply tank 322 is filled, the number of the pressure drop between the input water to a filter tank 324 and the output water from the filter tank 324 and at what time the system 100 triggers a fault because such a drop is over a threshold predetermined value. Moreover, in some examples, a trained user 40 may set up the filtration valves in a filtration valve setup screen not shown) to run individually to better trouble shoot any problem with the valves.

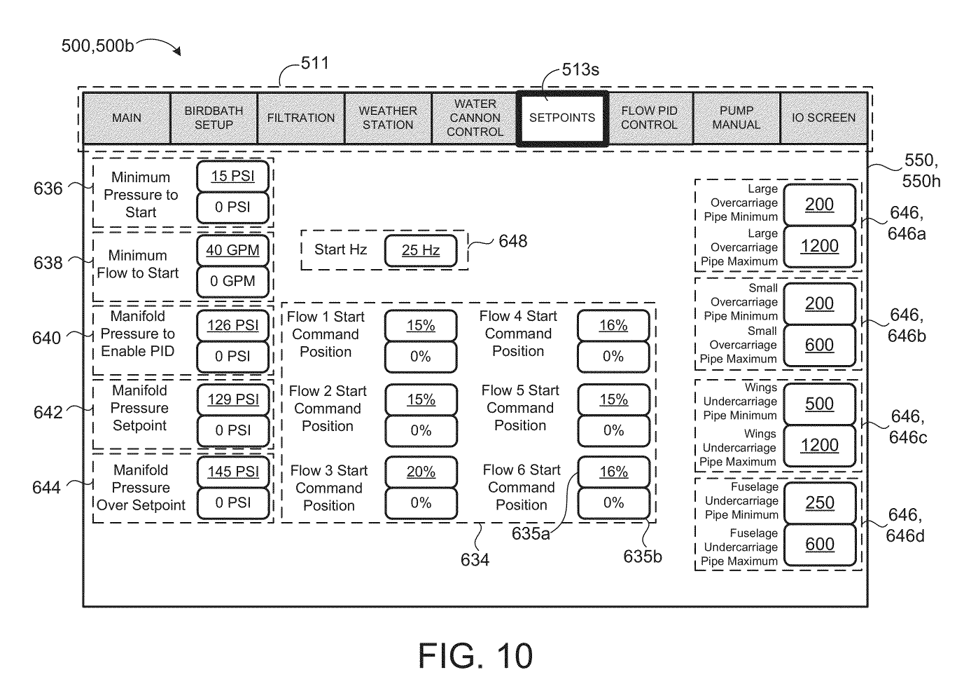

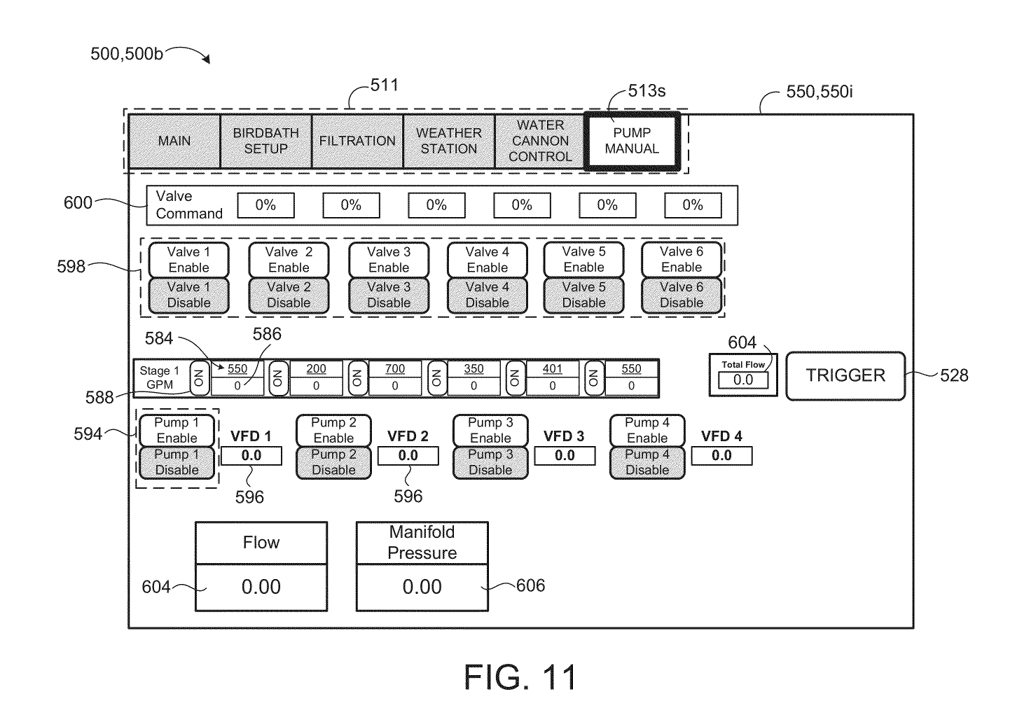

Referring to FIG. 10, the user interface 500 provides a set-point setup screen 550h. The set-point set up screen 550h allows the trained user 40 to set different initial values at which the system 100 initiates a washing routine. As previously discussed, when the pipes 17 do not contain water and instead contain air, it is harmful and damaging to the pipes 17 to blast fluid into the pipes 17 at full pressure. Therefore, the system 100 slowly fills the pipes 17 at a low pressure so that the system 100 is not damaged. Referring to a flow start command position portion 634 of the set-point setup screen 550h, the trained user 40 can determine the percentage that the valves are initially open. The trained user 40 inputs the value in an input box 635a, and while the system 100 is executing a rinsing routine, the actual percentage is shown in an output box 635b. The set-point setup screen 550h may include other features, such as a minimum pressure to start portion 636 where the user 40 enters a minimum start pressure. The minimum pressure to start portion 636 includes two values, one entered by the user 40 and another received by the pressure sensor indicating the current pressure. Similarly, the set-point setup screen 550h includes a minimum flow start portion 638, a manifold pressure to enable PID portion 640, a manifold pressure set-point portion 642, and a manifold pressure over set-point portion 644. These portions include a value entered by the user 40 and another that the system 100 reads from a sensor. The set-point setup screen 550h also includes a portion tier determining the minimum and maximum amount of water released 646. For example, a user 40 may determine the amount of fluid gallons per airplane portion. As another example, a user 40 may determine the maximum and minimum values for the large overcarriage pipe 646a, for the small overcarriage pipe 646b, for the wings undercarriage pipe 646c, and for the fuselage undercarriage pipe 646d. FIG. 11 is a maintenance screen 500i that allows a user 40 to turn on and off specific valves and pumps during a specific stage.

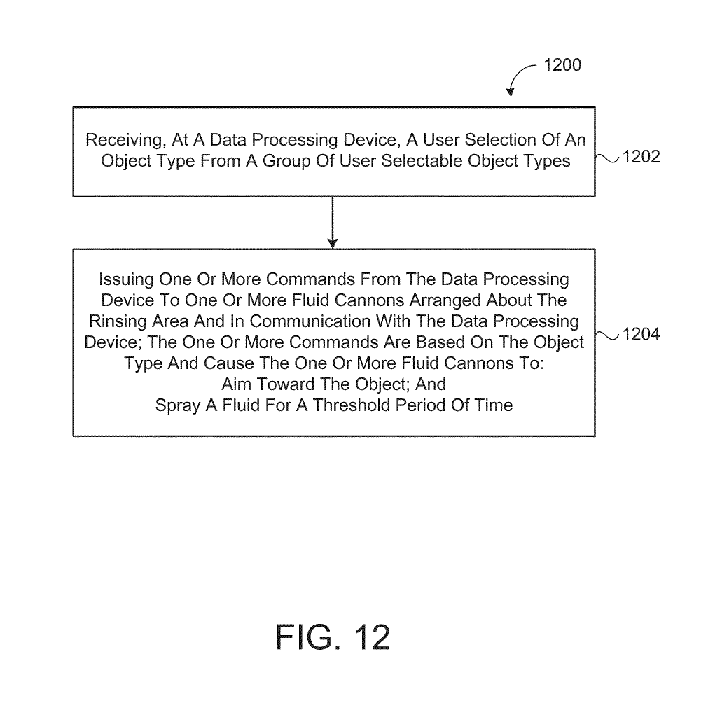

Referring to FIG. 12, a method 1200 for operating a data processing device 410 is shown. The method 1200 includes receiving 1202, at a data processing device 410 a selection of an object type from a group of selectable object types for an object 20 (e.g., airplane 20) within a rinsing area 202. The method 1200 includes issuing 1204 one or more commands from the data processing device 410, to one or more fluid cannons 220 arranged about the rinsing area 202 and in communication with the data processing device 410. One or more commands are based on the object type and cause the one or more fluid cannons 220 to aim toward the object 20 and spray a fluid 30 tier a threshold period of time.

In some implementations, the method 1200 includes defining multiple rinse zones 203 within the rinsing area 202. For each rinse zone 203, the method 1200 includes configuring one or more commands to execute when the object 20 advances through the rinse zone 203. Additionally or alternatively, for each rinse zone 203, the method 1200 may include determining a rinse zone threshold period of time for spraying fluid on the object 20 in the rinse zone 203.

In some implementations, the method 1200 includes receiving a cannon position parameter and a cannon flow pattern parameter and configuring the one or more commands based on the received parameters. The method 1200 may also include receiving a wind correction parameter and wind data 350 from a wind sensor 214, at the data processing device 410. The method 1200 further includes determining, using the data processing device 410, the cannon position parameter based on the wind correction parameter and the wind data 350. Additionally or alternatively, the wind data 350 may include one or more of a wind speed and a wind direction (received from a wind speed and direction sensor 214). The method 1200 may further include displaying the wind correction parameter, the wind data 350, and the cannon position parameter, on a user display 420 in communication with the data processing device 410.

In some examples, the one or more commands include one or more positioning commands for the positioning respective fluid cannon 220 and one or more pattern commands that set a spray pattern of the respective fluid cannon 220. In some examples, the one or more commands include one or more fluid rate commands that control a fluid valve 242 in communication with the data processing device 410. The fluid valve 242 is in fluid communication with a respective fluid cannon 220 and controlling a fluid rate to that fluid cannon 220. Additionally or alternatively, the method 1200 may further include defining multiple rinse zones 203 within the rinsing area 202, and, configuring a fluid flow rate for at least one fluid cannon 220 in at least one rinse zone 203.

In some examples, the method 1200 further includes issuing a filtration command from the data processing device 410 to a filtration system 300 to collect fluid 30 from the rinsing area 202 and filter the collected fluid 30. In some examples, the filtration command includes a valve position command for actuating a filtration valve of the filtration system 300. The filtration valve FV1-FV8 controls a flow of fluid 30 through the filtration system 300.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Implementations of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A washing system comprising:
one or more fluid cannons arranged about a rinsing area for rinsing an object; and
a data processing device in communication with the one or more fluid cannons, the data processing device executing a rinsing routine for rinsing the object within the rinsing area, the rinsing routine causing the data processing device to issue one or more commands based on an object type that cause the one or more fluid cannons to:
aim toward the object; and
spray a fluid for a threshold period of time.

2. The system of claim 1, wherein the data processing device:
receives a cannon position parameter and a cannon flow pattern parameter; and
configures the one or more commands based on the received parameters.

3. The system of claim 1, wherein the data processing device:
receives a selection of the object type from a group of selectable object types;
issues a position command to each fluid cannon, the position command defined based on the object type to aim the fluid cannon toward the object; and
issues a spray command to each fluid cannon, the spray command defined based on the object type to spray a fluid from the fluid cannon for a threshold period of time.

4. The system of claim 1, wherein the rinsing area defines multiple rinse zones, a different rinsing routine is associated with each rinse zone, each rinsing routine executes when the object advances through the rinse zone.

5. The system of claim 1, wherein each fluid cannon comprises:
a pan actuator;
a tilt actuator; and
a controller in communication with the actuators, the controller:
receiving the position command from the data processing device; and
actuating the actuators based on the position command to aim the fluid cannon.

6. The system of claim 5, wherein each fluid cannon further comprises:
an adjustable nozzle; and
a nozzle actuator adjusting a flow pattern of the nozzle;
wherein the spray command comprises a flow pattern parameter, the controller actuating the nozzle actuator based on the flow pattern parameter.

7. The system of claim 6, wherein each fluid cannon further comprises:
a valve in fluid communication with the nozzle; and
a valve actuator adjusting a position of the valve;
wherein the spray command comprises a flow rate parameter, the controller actuating the valve actuator based on the flow rate parameter.

8. The system of claim 7, wherein, for each rinse zone, the data processing device:
receives at least one of a position parameter, the flow pattern parameter, or the flow rate parameter for each fluid cannon disposed in the rinse zone; and
determines the position command and the spray command for each fluid cannon disposed in the rinse zone based on the at least one parameter.

9. The system of claim 7, wherein the data processing device determines a rinse zone threshold period of time for spraying fluid on the object in each rinse zone.

10. The system of claim 7, wherein the data processing device:
receives a wind correction parameter;
receives wind data from a wind sensor; and
determines the position parameter based on the wind correction parameter and the wind data.

11. The system of claim 10, wherein the wind data comprises one or more of a wind speed and a wind direction.

12. The system of claim 10, further comprising a user display in communication with the data processing device, the user display displaying the wind correction parameter, the wind data, and the position parameter.

13. The system of claim 1, further comprising a filtration system in communication with the data processing device, the data processing device monitoring collection and transfer of sprayed fluid to the filtration system.

14. The system of claim 13, wherein the filtration system comprises:
fluid drains capturing fluid from the rinsing area;
a recovery tank in fluid communication with the fluid drains and storing the captured fluid; and
a supply tank storing fluid filtered from the recovery tank.

15. The system of claim 14, wherein the filtration system further comprises:
a filtration valve in fluid communication with the recovery tank or the supply tank;
a filtration valve actuator adjusting a position of the filtration valve;
a filtration valve controller in communication with the filtration valve and the data processing device, the filtration valve controller:
receiving a valve position command from the data processing device; and
actuating the filtration valve actuator based on the valve position command.

16. A method comprising:
receiving, at a data processing device, a selection of an object type from a group of selectable object types fir an object within a rinsing area; and
issuing one or more commands from the data processing device to one or more fluid cannons arranged about the rinsing area and in communication with the data processing device, wherein the one or more commands are based on the object type and cause the one or more fluid cannons to:
aim toward the object; and
spray a fluid for a threshold period of time.

17. The method of claim 16, further comprising:
defining multiple rinse zones within the rinsing area; and
for each rinse zone, configuring one or more commands to execute when the object advances through the rinse zone.

18. The method of claim 11, further comprising, for each rinse zone, determining a rinse zone threshold period of time for spraying fluid on the object in the rinse zone.

19. The method of claim 16, further comprising:
receiving, at the data processing device, a cannon position parameter and a cannon flow pattern parameter; and
configuring the one or more commands based on the received parameters.

20. The method of claim 19, further comprising:
receiving, at the data processing device, a wind correction parameter;
receiving, at the data processing device, wind data from a wind sensor; and
determining, using the data processing device, the cannon position parameter based on the wind correction parameter and the wind data.

21. The method of claim 20, wherein the wind data comprises one or more of a wind speed and a wind direction.

22. The method of claim 20, further comprising displaying, on a user display in communication with the data processing device, the wind correction parameter, the wind data, and the cannon position parameter.

23. The method of claim 16, wherein the one or more commands comprise:
one or more positioning commands for positioning a respective fluid cannon; and
one or more pattern commands that set a spray pattern of the respective fluid cannon.

24. The method of claim 16, wherein the one or more commands comprise one or more fluid flow rate commands that control a fluid valve in communication with the data processing device, the fluid valve in fluid communication with a respective fluid cannon and controlling a fluid rate to that fluid cannon.

25. The method of claim 24, further comprising:
defining multiple rinse zones within the rinsing area; and
configuring a fluid flow rate for at least one fluid cannon in at least one rinse zone.

26. The method of claim 16, further comprising issuing a filtration command from the data processing device to a filtration system to collect fluid from the rinsing area and filter the collected fluid.

27. The method of claim 26, wherein the filtration command comprises a valve position command for actuating a filtration valve of the filtration system, the filtration valve controlling a flow of fluid through the filtration system.
